(19) United States
(12) Patent Application Publication
(10) Pub. No.: US 2023/0007684 A1
(43) Pub. Date: Jan. 5, 2023

(54) METHOD AND APPARATUS FOR COORDINATED COMMUNICATION

(71) Applicant: Huawei Technologies Co., Ltd., Shenzhen (CN)

(72) Inventors: Yuchen GUO, Shenzhen (CN); Yunbo LI, Shenzhen (CN); Ming GAN, Shenzhen (CN); Jian YU, Shenzhen (CN); Guogang HUANG, Shenzhen (CN)

(21) Appl. No.: 17/942,888

(22) Filed: Sep. 12, 2022

Related U.S. Application Data
(63) Continuation of application No. PCT/CN2021/079805, filed on Mar. 9, 2021.

(30) Foreign Application Priority Data
Mar. 13, 2020 (CN) 202010177367.6

(51) Int. Cl. H04W 74/08; H04W 74/06

(52) U.S. Cl. CPC H04W 74/085; H04W 74/0866; H04W 74/06

(57) ABSTRACT

A method for coordinated communication and an apparatus for coordinated communication are provided. The method includes: a first access point (AP) sends an announcement message and/or a polling message to one or more second APs. The announcement message announces that the first AP may share a time resource of the first AP. The announcement message may further include identifier information that indicates the one or more second APs, and time information that indicate communication or channel contention of the one or more second APs in the time resource shared by the first AP. The polling message may be used to notify a second AP to start to use, at a preset time, a channel resource shared by the first AP with the second AP for communication or start channel contention at the preset time.

### CROSS-REFERENCE TO RELATED APPLICATION

This application is a continuation of International Application No. PCT/CN2021/079805, filed on Mar. 9, 2021, which claims priority to Chinese Patent Application No. 202010177367.6, filed on Mar. 13, 2020. The disclosure of the aforementioned applications are hereby incorporated by reference in their entireties

### TECHNICAL FIELD

Embodiments of this application relate to the field of wireless communication, and more specifically, to a method for coordinated communication and an apparatus used in coordinated communication.

### BACKGROUND

With development of wireless networks and popularization of wireless local area network (WLAN) technologies, WLAN devices become increasingly dense. Wireless access points (AP) are easily deployed, and increasingly dense APs also cause more inter-cell interference.

How to reduce inter-cell interference and improve service quality for a user through AP coordination is a problem that needs to be considered in a next-generation wireless fidelity (Wi-Fi) technology.

### SUMMARY

This application provides a method for coordinated communication and an apparatus used in coordinated communication, to implement multi-device coordinated communication. In this way, the plurality of devices in coordinated communication can freely transmit data, and flexibility of data transmission is improved.

According to a first aspect, a method for coordinated communication is provided. The method may be performed by a first device, or may be performed by a chip, a circuit, or a processing system configured in the first device. This is not limited in this application. For example, due to a difference in an integration level, the first device may be an entire device, or may be a part of an entire device, for example, a chip system or a processing system. This is not limited in this application. The first device may be, for example, an access point. The following describes an example in which the method is performed by a first access point (AP).

The method may include: A first access point AP obtains a transmit opportunity (TXOP); and the first AP sends an announcement message. The announcement message announces that the first AP shares the TXOP, and the announcement message includes identifier information that indicates N second AP and information that indicates a time resource for the N second AP to perform communication in the TXOP, and N is an integer greater than or equal to 1.

Optionally, that the first AP shares the TXOP may be understood as that the first AP shares the TXOP with the N second AP. That the first AP shares the TXOP or the first AP shares the TXOP with the N second AP may include: The first AP shares all of the TXOP with the N second AP, or the first AP shares a remaining part of the TXOP with the N second AP after completing data transmission.

Optionally, that the first AP shares the TXOP may also be understood as that the first AP shares a channel resource obtained by the first AP in the TXOP.

Based on the foregoing technical solution, the first AP may share the TXOP of the first AP with one or more second APs, reducing overheads caused by channel contention performed again by another AP (that is, the one or more second APs), and improving resource utilization. In addition, when the first AP shares the time resource with the N second AP, an appropriate time resource may be allocated to each second AP in advance, and each second AP may perform transmission on a time resource corresponding to each second AP. In this way, each second AP may directly send data to a station STA, so that data can be transmitted freely, transmission latency can be reduced, and flexibility of data transmission can be improved.

With reference to the first aspect, in some implementations of the first aspect, the identifier information that indicates the N second AP includes an identifier of each second AP, or a group identifier of a group to which a second AP belongs.

Based on the foregoing technical solution, the first AP carries the identifier of the second AP or the group identifier of the group to which the second AP belongs in the announcement message, so that another AP may determine, based on whether an identifier of the another AP or a group identifier of a group to which the another AP belongs is in the announcement message, whether the another AP can share the time resource (such as the TXOP) of the first AP.

With reference to the first aspect, in some implementations of the first aspect, the information that indicates the time resource for the N second AP to perform communication in the TXOP includes one or more of the following: duration of a time resource for each second AP to perform communication in the TXOP, start time of the time resource for each second AP to perform communication in the TXOP, and end time of the time resource for each second AP to perform communication in the TXOP.

For example, the duration of the time resource for the second AP to perform communication in the TXOP may be duration of using a channel of the first AP by the second AP. The channel is a channel allocated by the first AP to the second AP, or a channel shared by the first AP with the second AP.

For example, the start time of the time resource for the second AP to perform communication in the TXOP may be start time at which the second AP uses the channel of the first AP.

For example, the end time of the time resource for the second AP to perform communication in the TXOP may be end time at which the second AP uses the channel of the first AP.

Based on the foregoing technical solution, time information of the second AP, for example, duration of a time resource that can be used by the second AP, start time of the time resource that can be used by the second AP, and end time of the time resource that can be used by the second AP, is carried in the announcement message, so that the second AP can transmit data within a time period corresponding to the second AP.

With reference to the first aspect, in some implementations of the first aspect, the announcement message includes one or more of the following: an identifier of a link used by each second AP, an identifier of a channel used by each second AP, or sequence information of the N second AP. The sequence information of the N second AP indicates a sequence of using the channel by the N second AP.

In an example, the announcement message may include sequence information of the N second AP, to indicate a sequence of sharing the TXOP by the N second AP. The N second AP may determine a sequence of sharing the TXOP based on the sequence information.

In another example, the second AP may determine a sequence of sharing the TXOP based on a sequence in which the identifiers appear.

Optionally, the sequence of sharing the TXOP by the N second AP one-to-one correspond to the identifiers of the N second AP.

With reference to the first aspect, in some implementations of the first aspect, the N second AP include a third AP, and the method further includes: The first AP sends a first polling message to the third AP. The first polling message indicates the third AP to start to use, at first preset time, a channel resource allocated by the first AP to the third AP.

Based on the foregoing technical solution, when sharing the time resource with the N second AP, the first AP may allocate an appropriate transmission resource to each second AP in a dynamic or real-time manner based on a data transmission status of each second AP. Therefore, each second AP can perform transmission on a transmission resource allocated by the first AP. This can further improve resource utilization, and reduce resource waste.

With reference to the first aspect, in some implementations of the first aspect, the first polling message includes duration of using, by the third AP, the channel resource allocated by the first AP to the third AP.

With reference to the first aspect, in some implementations of the first aspect, the N second AP include a fourth AP and a fifth AP, and the method further includes: After the first AP determines that data transmission of the fourth AP is completed, the first AP sends a second polling message to the fifth AP. The second polling message indicates the fifth AP to start to use, at second preset time, a channel resource allocated by the first AP to the fifth AP

With reference to the first aspect, in some implementations of the first aspect, that the first AP determines that data transmission of the fourth AP is completed includes: After receiving a return message from the fourth AP, the first AP determines that data transmission of the fourth AP is completed. The return message is used to return a remaining time resource of a time resource allocated by the first AP to the fourth AP. Alternatively, the first AP receives indication information from the fourth AP, and determines, based on the indication information, that data transmission of the fourth AP is completed. The indication information indicates to return a remaining time resource of a time resource allocated by the first AP to the fourth AP.

With reference to the first aspect, in some implementations of the first aspect, the indication information is carried in any one of the following: a more data subfield in a control field of a last data frame transmitted by the fourth AP; a more fragment subfield in a quality of service control field of a last data frame transmitted by the fourth AP; an end of service period EOSP subfield in a quality of service control field of a last data frame transmitted by the fourth AP; a duration field of a last data frame transmitted by the fourth AP; or a more trigger frame (more TF) field of a last trigger frame transmitted by the fourth AP.

According to a second aspect, a method for coordinated communication is provided. The method may be performed by a first device, or may be performed by a chip, a circuit, or a processing system configured in the first device. This is not limited in this application. For example, due to a difference in an integration level, the first device may be an entire device, or may be a part of an entire device, for example, a chip system or a processing system. This is not limited in this application. The first device may be, for example, an access point, and an access point device may also be referred to as an access point. The following describes an example in which the method is performed by a first access point AP.

The method may include: A first access point AP obtains a transmit opportunity (TXOP); and the first AP sends an announcement message. The announcement message announces that the first AP shares the TXOP, and the announcement message includes indication information. The indication information indicates that N second AP can use, in a channel contention manner, a channel resource obtained by the first AP in the TXOP, and N is an integer greater than or equal to 1.

Based on the foregoing technical solution, a plurality of APs may share a time resource. For example, the first AP may send an announcement message, the announcement message carries indication information, and the indication information may indicate that the second AP may transmit data in a channel contention manner. For example, each second AP may transmit data in a channel contention manner within a time period corresponding to each second AP. Therefore, coordination between the plurality of APs can be implemented, and the second AP can directly send data to a STA after successfully contending for a channel, so that data can be transmitted freely, transmission latency can be reduced, and flexibility of data transmission can be improved. In addition, by using this solution, the first AP does not need to know a transmission requirement of the second AP, and does not need to carry identifier information of each second AP in the announcement message. Signaling overheads are low, and transmission efficiency is high.

With reference to the second aspect, in some implementations of the second aspect, the indication information includes information about a preset identifier. The information about the preset identifier indicates that an AP that belongs to a same coordination set as the first AP can use, in a channel contention manner, the channel resource obtained by the first AP in the TXOP. The N second AP and the first AP are APs belonging to the same coordination set.

For example, the information about the preset identifier is a preset AP identifier ID, or in other words, the information about the preset identifier is a special AP ID.

With reference to the second aspect, in some implementations of the second aspect, the transmission mode information indicates whether the second AP uses, in a channel contention manner, the channel resource obtained by the first AP in the TXOP.

In an example, the transmission mode information may indicate whether the second AP can transmit data in a channel contention manner.

In another example, the transmission mode information may indicate whether the second AP needs to transmit data in a channel contention manner.

With reference to the second aspect, in some implementations of the second aspect, the announcement message includes information that indicates a time resource on which each second AP can perform channel contention.

Based on the foregoing technical solution, each second AP contends, based on time information in the announcement message, for a channel on a time resource allocated by the first AP to each second AP.

With reference to the second aspect, in some implementations of the second aspect, the information that indicates the time resource on which each second AP can perform channel contention includes one or more of the following: duration of channel contention of each second AP, start time of channel contention of each second AP, and end time of channel contention of each second AP.

With reference to the second aspect, in some implementations of the second aspect, the N second AP include a third AP, and the method further includes: The first AP sends a third polling message to the third AP. The third polling message indicates the third AP to start channel contention at third preset time.

Based on the foregoing technical solution, each second AP may transmit data in a channel contention manner based on a polling message received by the second AP.

With reference to the second aspect, in some implementations of the second aspect, the first AP sends parameter information. The parameter information includes a parameter used by the second AP for channel contention.

For example, the parameter information may include but is not limited to a minimum contention window, a maximum contention window, or an arbitrary inter-frame space.

With reference to the first aspect or the second aspect, in some implementations, before the first AP sends the announcement message, the method further includes: The first AP receives a request message from the second AP. The request message is used to request to transmit data in a multi-AP coordination manner.

For example, before the first AP sends the announcement message, the method further includes: The first AP receives a request message from the second AP. The request message is used to request to share the TXOP with the first AP.

Based on the foregoing technical solution, the first AP may determine, based on the request message of the second AP, a second AP that can share the TXOP of the first AP. This prevents the first AP from randomly sharing the TXOP with an AP that does not need to transmit data, improving resource utilization as much as possible.

With reference to the first aspect or the second aspect, in some implementations, the request message includes one or more of the following: a coordination type, a transmission resource needed by the second AP, a service volume transmitted by the second AP, and a scheduling policy to be used by the second AP.

Based on the foregoing technical solution, when the plurality of APs coordinate with each other, appropriate processing may be performed based on a transmission requirement of each AP, for example, a coordination type expected by the AP, a quantity of resources needed by the AP for data transmission, a service volume transmitted by the AP, and a scheduling policy to be used by the AP. For example, the first AP may perform corresponding configuration based on a coordination type expected by the second AP.

With reference to the first aspect or the second aspect, in some implementations, the method further includes: The first AP sends information about an AP coordination set. The information about the AP coordination set indicates coordinated transmission between the first AP and an AP in the AP coordination set.

For example, the information about the AP coordination set may be carried in a beacon frame, or the information about the AP coordination set may be carried in a physical layer preamble of a physical layer protocol data unit.

Based on the foregoing technical solution, communication may be performed based on an established AP coordination set. This can not only make coordination between the plurality of APs more coordinated, but also improve communication performance between the plurality of APs and the STA.

With reference to the first aspect or the second aspect, in some implementations, the information about the AP coordination set includes one or more of the following: a coordination type of the AP in the AP coordination set, an identifier of the AP coordination set, an identifier of the AP in the AP coordination set, a basic service set color BSS color of the AP in the AP coordination set, and a working channel of the AP in the AP coordination set.

According to a third aspect, a method for coordinated communication is provided. The method may be performed by a third device, or may be performed by a chip, a circuit, or a processing system configured in the third device. This is not limited in this application. For example, due to a difference in an integration level, the third device may be an entire device, or may be a part of an entire device, for example, a chip system or a processing system. This is not limited in this application. The third device may be, for example, an access point. The following describes an example in which the method is performed by a third access point AP.

The method may include: A third access point AP receives an announcement message from a first AP. The announcement message announces that the first AP shares a transmit opportunity (TXOP), and the announcement message includes identifier information that indicates N second AP and information that indicates a time resource for the N second AP to perform communication in the TXOP. The N second AP include the third AP, and N is an integer greater than or equal to 1.

With reference to the third aspect, in some implementations of the third aspect, the identifier information that indicates the N second AP includes an identifier of each second AP, or a group identifier of a group to which a second AP belongs.

With reference to the third aspect, in some implementations of the third aspect, the information that indicates the time resource for the N second AP to perform communication in the TXOP includes one or more of the following: duration of a time resource for each second AP to perform communication in the TXOP, start time of the time resource for each second AP to perform communication in the TXOP, and end time of the time resource for each second AP to perform communication in the TXOP.

With reference to the third aspect, in some implementations of the third aspect, the announcement message includes one or more of the following: an identifier of a link used by each second AP, an identifier of a channel used by each second AP, or sequence information of the N second AP. The sequence information of the N second AP indicates a sequence of using the channel by the N second AP.

With reference to the third aspect, in some implementations of the third aspect, the method further includes: The third AP receives a first polling message from the first AP, where the first polling message indicates the third AP to start to use, at first preset time, a channel resource allocated by the first AP to the third AP; and the third AP starts to use, based on the first polling message and at the first preset time, the channel resource allocated by the first AP to the third AP.

With reference to the third aspect, in some implementations of the third aspect, the method further includes: The third AP sends a return message to the first AP. The return message is used to return a remaining time resource of a time resource allocated by the first AP to the third AP. Alternatively, the third AP sends a transfer message to a fourth AP. The transfer message is used to transfer, to the fourth AP, a remaining time resource of a time resource allocated by the first AP to the third AP, and the fourth AP belongs to the N second AP.

With reference to the third aspect, in some implementations of the third aspect, the method further includes: The third AP sends indication information. The indication information indicates the remaining time resource of the time resource allocated by the first AP to the third AP.

With reference to the third aspect, in some implementations of the third aspect, the indication information is carried in any one of the following: a more data subfield in a control field of a last data frame transmitted by the third AP; a more fragment subfield in a quality of service control field of a last data frame transmitted by the third AP; an end of service period EOSP subfield in a quality of service control field of a last data frame transmitted by the third AP; a duration field of a last data frame transmitted by the third AP; or a more trigger frame (more TF) field of a last trigger frame transmitted by the third AP.

According to a fourth aspect, a method for coordinated communication is provided. The method may be performed by a third device, or may be performed by a chip, a circuit, or a processing system configured in the third device. This is not limited in this application. For example, due to a difference in an integration level, the third device may be an entire device, or may be a part of an entire device, for example, a chip system or a processing system. This is not limited in this application. The third device may be, for example, an access point. The following describes an example in which the method is performed by a third access point AP.

The method may include: A third access point AP receives an announcement message from a first AP. The announcement message announces that the first AP shares a transmit opportunity (TXOP), and the announcement message includes indication information. The indication information indicates that N second AP can use, in a channel contention manner, a channel resource obtained by the first AP in the TXOP. The N second AP include the third AP, and N is an integer greater than or equal to 1.

With reference to the fourth aspect, in some implementations of the fourth aspect, the indication information includes information about a preset identifier. The information about the preset identifier indicates that an AP that belongs to a same coordination set as the first AP can use, in a channel contention manner, the channel resource obtained by the first AP in the TXOP. The N second AP and the first AP are APs belonging to the same coordination set.

With reference to the fourth aspect, in some implementations of the fourth aspect, the indication information includes an identifier and transmission mode information of each second AP. The transmission mode information indicates the second AP to use, in a channel contention manner, the channel resource obtained by the first AP in the TXOP; and the third AP determines, based on to the transmission mode information, to use, in a channel contention manner, the channel resource obtained by the first AP in the TXOP.

With reference to the fourth aspect, in some implementations of the fourth aspect, the announcement message includes information that indicates a time resource on which each second AP can perform channel contention; and the third AP performs channel contention based on information that is in the announcement message and that indicates a time resource on which the third AP can perform channel contention.

With reference to the fourth aspect, in some implementations of the fourth aspect, the information that indicates the time resource on which each second AP can perform channel contention includes one or more of the following: duration of channel contention of each second AP, start time of channel contention of each second AP, and end time of channel contention of each second AP.

With reference to the fourth aspect, in some implementations of the fourth aspect, the method further includes: The third AP receives a third polling message from the first AP, where the third polling message indicates the third AP to start channel contention at third preset time; and the third AP performs channel contention based on the third polling message.

With reference to the fourth aspect, in some implementations of the fourth aspect, the third AP receives parameter information from the first AP. The parameter information includes a parameter used by the third AP for channel contention.

With reference to the third aspect or the fourth aspect, in some implementations, before the third AP receives the announcement message from the first AP, the method further includes: The third AP sends a request message to the first AP. The request message is used to request to share the TXOP with the first AP.

With reference to the third aspect or the fourth aspect, in some implementations, the request message includes one or more of the following: a coordination type of the third AP is coordinated time division multiplexing, a transmission resource needed by the third AP, a service volume transmitted by the third AP, and a scheduling policy to be used by the third AP.

According to a fifth aspect, a method for coordinated communication is provided. The method may be performed by a fourth device, or may be performed by a chip, a circuit, or a processing system configured in the fourth device. This is not limited in this application. For example, due to a difference in an integration level, the fourth device may be an entire device, or may be a part of an entire device, for example, a chip system or a processing system. This is not limited in this application. The fourth device may be, for example, an access point. The following describes an example in which the method is performed by a fourth access point AP.

The method may include: A fourth access point AP receives a transfer message from a third AP, where the transfer message is used to transfer, to the fourth AP, a remaining time resource of a time resource allocated by a first AP to the third AP; and the fourth AP transmits data by using a channel resource allocated by the first AP to the fourth AP. The first AP can share a transmit opportunity (TXOP) of the first AP with N second AP, the N second AP include the third AP and the fourth AP, and N is an integer greater than or equal to 2.

With reference to the fifth aspect, in some implementations of the fifth aspect, the fourth AP can use the remaining time resource of the time resource allocated by the first AP to the third AP to transmit data.

According to a sixth aspect, a method for coordinated communication is provided. The method may be performed by a second device, or may be performed by a chip, a circuit, or a processing system configured in the second device. This is not limited in this application. For example, due to a difference in an integration level, the second device may be an entire device, or may be a part of an entire device, for example, a chip system or a processing system. This is not limited in this application. The second device may be, for example, an access point. The following mainly uses an example in which the second device is a second AP for description.

The method may include: A second AP sends a request message to a first AP, where the request message is used to request to transmit data in a multi-device coordination manner; and the second AP receives an announcement message from the first AP, where the announcement message announces that the first AP shares a transmission resource.

Optionally, the transmission resource may include a time resource (for example, a transmit opportunity (TXOP)) and/or a frequency resource.

Optionally, the announcement message announces that the first AP shares the TXOP. For content of sharing the TXOP by the first AP, refer to the content in the first aspect to the fifth aspect.

Optionally, the method further includes: The second AP receives an inquiry message from the first AP. The inquiry message includes a coordination type expected by the first AP, and the inquiry message is used to inquire whether the second AP participates in the coordination type expected by the first AP.

Optionally, before the second AP sends the request message to the first AP, the method further includes: The second AP reports AP capability information.

According to a seventh aspect, a method for coordinated communication is provided. The method may be performed by a first device, or may be performed by a chip, a circuit, or a processing system configured in the first device. This is not limited in this application. For example, due to a difference in an integration level, the second device may be an entire device, or may be a part of an entire device, for example, a chip system or a processing system. This is not limited in this application. The first device may be, for example, an access point. The following mainly uses an example in which the first device is a first AP for description.

The method may include: A first AP receives a request message from a second AP, where the request message is used to request to transmit data in a multi-device coordination manner; and the first AP sends an announcement message to the second AP based on the request message, where the announcement message announces that the first AP shares a transmission resource.

Optionally, the transmission resource may include a time resource (for example, a transmit opportunity (TXOP)) and/or a frequency resource.

Optionally, the announcement message announces that the first AP shares the TXOP. For content of sharing the TXOP by the first AP, refer to the content in the first aspect to the fifth aspect.

Optionally, the method further includes: The first AP sends an inquiry message to the second AP. The inquiry message includes a coordination type expected by the first AP, and the inquiry message is used to inquire whether the second AP participates in the coordination type expected by the first AP.

Optionally, before the first AP sends the inquiry message to the second AP, the method further includes: The first AP obtains AP capability information reported by the second AP.

Based on the foregoing technical solution, when intending to perform coordinated communication with the first AP, the second AP may send the request message to the first AP, so that the first AP performs corresponding processing based on the request message of the second AP. For example, if the first AP determines, based on the request message of the second AP, that the first AP can share the transmission resource with the second AP, the second AP sends the announcement message to the first AP, to notify the second AP that the first AP can share the transmission resource with the second AP. In addition, the first AP may further carry information related to sharing of the transmission resource with the second AP, for example, duration of using a channel by the second AP, start time of using the channel by the second AP, end time of using the channel by the second AP, or whether the second AP needs to perform transmission in a channel contention manner. For details, refer to the content in the first aspect to the fifth aspect.

With reference to the sixth aspect or the seventh aspect, in some implementations, the request message includes one or more of the following: a coordination type, a transmission resource needed by the second AP, a service volume transmitted by the second AP, and a scheduling policy to be used by the second AP.

In an example, the request message may include a coordination type. Information about the coordination type is carried in the request message, so that the first AP learns of the coordination type requested by the second AP, and the first AP makes corresponding preparations based on the requested coordination type.

In another example, the request message may include a quantity of resources needed for transmission. The quantity of resources needed for transmission is carried in the request message, so that the first AP can learn of a transmission resource needed by the second AP for data transmission, and the first AP allocates an appropriate transmission resource to the second AP, improving resource utilization.

In still another example, the request message may include a service volume that needs to be transmitted. The service volume that needs to be transmitted is carried in the request message, so that the first AP can allocate an appropriate transmission resource to or perform corresponding configuration on the second AP based on the service volume that needs to be transmitted by the second AP. This can improve resource utilization.

In yet another example, the request message may include a scheduling policy to be used. The scheduling policy to be used is carried in the request message, so that the first AP can learn of the scheduling policy to be used by the second AP, and the first AP performs corresponding configuration or preparation.

According to an eighth aspect, a method for coordinated communication is provided. The method may be performed by a device, for example, an access point, or may be performed by a chip, a circuit, or a processing system configured in the device. This is not limited in this application. For example, due to a difference in an integration level, the device may be an entire device, or may be a part of an entire device, for example, a chip system or a processing system. This is not limited in this application. The following mainly uses an example in which the device is an AP for description.

The method may include: An AP obtains information about an AP coordination set; and the AP sends a data frame to a station STA. The data frame includes information that indicates the AP coordination set.

According to a ninth aspect, a method for coordinated communication is provided. The method may be performed by a device, for example, a station device, and the station device may also be referred to as a station. Alternatively, the method may be performed by a chip, a circuit, or a processing system configured in the device. This is not limited in this application. For example, due to a difference in an integration level, the device may be an entire device, or may be a part of an entire device, for example, a chip system or a processing system. This is not limited in this application. The following mainly uses an example in which the device is a STA for description.

The method may include: A STA receives a data frame from an AP, where the data frame includes information that indicates an AP coordination set; and the STA receives, based on the information that indicates the AP coordination set, data transmitted by an AP included in the AP coordination set.

Based on the foregoing technical solution, communication may be performed based on an established AP coordination set when a plurality of APs coordinate with each other. This can not only make coordination between the plurality of APs more coordinated, but also improve communication performance between the plurality of APs and the STA.

With reference to the eighth aspect or the ninth aspect, in some implementations, for example, the information about the AP coordination set may include one or more of the following: a coordination type of each AP, a coordination set identifier, an identifier of each AP in the coordination set, a basic service set color BSS color of each AP in the coordination set, and a working channel of each AP.

For example, the identifier of each AP in the coordination set may be an address of the AP, for example, a media access control (MAC) address; or may be an AP ID in a short length, for example, a length of 11 bits or 12 bits.

According to a tenth aspect, a method for coordinated communication is provided. The method may be performed by a second device, or may be performed by a chip, a circuit, or a processing system configured in the second device. This is not limited in this application. For example, due to a difference in an integration level, the second device may be an entire device, or may be a part of an entire device, for example, a chip system or a processing system. This is not limited in this application. The second device may be a device, for example, an access point. The following mainly uses an example in which the second device is a second AP for description.

The method may include: A second AP reports AP capability information, and receives an announcement message or an inquiry message from a first AP. The announcement message announces that the first AP shares a transmission resource, the inquiry message includes a coordination type expected by the first AP, and the inquiry message is used to inquire whether the second AP participates in the coordination type expected by the first AP.

Optionally, the second AP broadcasts the AP capability information in a broadcast manner.

Optionally, the transmission resource may include a time resource (for example, a transmit opportunity (TXOP)) and/or a frequency resource.

Optionally, the announcement message announces that the first AP shares the TXOP. For content of sharing the TXOP by the first AP, refer to the content in the first aspect to the fifth aspect.

According to an eleventh aspect, a method for coordinated communication is provided. The method may be performed by a first device, or may be performed by a chip, a circuit, or a processing system configured in the first device. This is not limited in this application. For example, due to a difference in an integration level, the first device may be an entire device, or may be a part of an entire device, for example, a chip system or a processing system. This is not limited in this application. The first device may be a device, for example, an access point. The following mainly uses an example in which the first device is a first AP for description.

The method may include: obtaining, A first AP obtains AP capability information of a second AP; and the first AP sends an announcement message or an inquiry message to the second AP based on the AP capability information of the second AP. The announcement message announces that the first AP shares a transmission resource, the inquiry message includes a coordination type expected by the first AP, and the inquiry message is used to inquire whether the second AP participates in the coordination type expected by the first AP.

Optionally, the transmission resource may include a time resource (for example, a transmit opportunity (TXOP)) and/or a frequency resource.

Optionally, the announcement message announces that the first AP shares the TXOP. For content of sharing the TXOP by the first AP, refer to the content in the first aspect to the fifth aspect.

Based on the foregoing technical solution, the second AP may broadcast the AP capability information of the second AP, so that when a plurality of APs coordinate with each other, each AP may determine, based on AP capability information of each AP, whether to coordinate with each other. In this way, a more appropriate coordination relationship may be established, and performance of coordinated communication between the plurality of APs may also be improved.

With reference to the tenth aspect or the eleventh aspect, in some implementations, the AP capability information of the second AP includes one or more of the following: an AP coordination form supported by the second AP, whether the second AP supports switching to a temporary primary channel, and whether the second AP supports sending of common physical layer preamble information.

Optionally, the AP coordination form supported by the second AP may include but is not limited to coordinated time division multiplexing access (coordinated TDMA), coordinated frequency division multiplexing access (coordinated FDMA), coordinated orthogonal frequency division multiplexing access (coordinated OFDMA), coordinated beamforming (coordinated beamforming), coordinated spatial reuse, and the like.

In an example, the AP capability information of the second AP includes an AP coordination form supported by the second AP. By broadcasting the AP coordination form supported by the second AP, another AP such as the first AP may learn of the AP coordination form supported by the second AP, so that the first AP determines, based on the AP coordination form supported by the second AP, whether to coordinate with the second AP, and may make corresponding preparations.

According to a twelfth aspect, an apparatus used in coordinated communication is provided, and is configured to perform the method in any possible implementation of the foregoing aspects. Specifically, the apparatus includes units configured to perform the method in any possible implementation of the foregoing aspects.

According to a thirteenth aspect, another apparatus used in coordinated communication is provided. The apparatus includes a processor. The processor is coupled to a memory, and may be configured to execute instructions in the memory, to implement the method in any possible implementation of the first aspect to the eleventh aspect. The memory may be an on-chip storage unit inside the processor, or may be an off-chip storage unit that is coupled to the memory and that is located outside the processor. In a possible implementation, the apparatus further includes the memory. In a possible implementation, the apparatus further includes a communication interface, and the processor is coupled to the communication interface.

In a possible implementation, the apparatus used in coordinated communication may be a first device (for example, an access point), may be a chip, a circuit, or a processing system configured in the first device, or may be a device including the first device.

In another possible implementation, the apparatus used in coordinated communication may be a second device (for example, an access point), may be a chip, a circuit, or a processing system configured in the second device, or may be a device including the second device.

In still another possible implementation, the apparatus used in coordinated communication may be a station device (for example, a station), may be a chip, a circuit, or a processing system configured in the station device, or may be a device including the station device.

In an implementation, the apparatus is a first device or a device including the first device. When the apparatus is a first device or a device including the first device, the communication interface may be a transceiver or an input/output interface. Optionally, the transceiver may be a transceiver circuit.

In another implementation, the apparatus is a chip disposed in the first device. When the apparatus is a chip configured in the first device, the communication interface may be an input/output interface, an interface circuit, an output circuit, an input circuit, a pin, a related circuit, or the like. The processor may alternatively be embodied as a processing circuit or a logic circuit.

In still another implementation, the apparatus is a second device or a device including the second device. When the apparatus is a second device or a device including the second device, the communication interface may be a transceiver or an input/output interface. Optionally, the transceiver may be a transceiver circuit.

In yet another implementation, the apparatus is a chip disposed in the second device. When the apparatus is a chip configured in the second device, the communication interface may be an input/output interface, an interface circuit, an output circuit, an input circuit, a pin, a related circuit, or the like. The processor may alternatively be embodied as a processing circuit or a logic circuit.

In still yet another implementation, the apparatus is a station device or a device including the station device. When the apparatus is a station device or a device including the station device, the communication interface may be a transceiver or an input/output interface. Optionally, the transceiver may be a transceiver circuit.

In a further implementation, the apparatus is a chip disposed in the station device. When the apparatus is a chip configured in the station device, the communication interface may be an input/output interface, an interface circuit, an output circuit, an input circuit, a pin, a related circuit, or the like. The processor may alternatively be embodied as a processing circuit or a logic circuit.

According to a fourteenth aspect, a computer-readable storage medium is provided. The computer-readable storage medium stores a computer program. When the computer program is executed by an apparatus, the apparatus is enabled to implement the method in any possible implementation of the foregoing aspects.

According to a fifteenth aspect, a computer program product including instructions is provided. When the instructions are executed by a computer, a communication apparatus is enabled to implement the method in any possible implementation of the foregoing aspects.

According to a sixteenth aspect, a system for coordinated communication is provided. The system includes the foregoing first device and second device.

### BRIEF DESCRIPTION OF DRAWINGS

FIG. 1 shows a schematic diagram of a communication system applicable to an embodiment of this application;

FIG. 2 shows a schematic diagram of multi-link communication;

FIG. 3 is a schematic diagram of a method for coordinated communication according to an embodiment of this application;

FIG. 4 is a schematic diagram of a method for coordinated communication applicable to an embodiment of this application;

FIG. 5 shows a schematic diagram depicting a frame structure of an announcement frame applicable to an embodiment of this application;

FIG. 6 is another schematic diagram of a method for coordinated communication applicable to an embodiment of this application;

FIG. 7 is a schematic diagram of a method for coordinated communication according to another embodiment of this application;

FIG. 8 is a schematic diagram of a method for coordinated communication applicable to another embodiment of this application;

FIG. 9 and FIG. 10 separately shows schematic diagram depicting a frame structure of a polling frame applicable to an embodiment of this application;

FIG. 11 is another schematic diagram of a method for coordinated communication applicable to another embodiment of this application;

FIG. 12 is a schematic diagram of a method for coordinated communication according to another embodiment of this application;

FIG. 13 shows a schematic diagram of a transmission return frame applicable to another embodiment of this application;

FIG. 14 shows a schematic diagram of a transmission transfer frame applicable to another embodiment of this application;

FIG. 15 is a schematic diagram of a method for coordinated communication according to still another embodiment of this application;

FIG. 16 shows a schematic diagram of a method for coordinated communication applicable to still another embodiment of this application;

FIG. 17 is another schematic diagram of a method for coordinated communication applicable to still another embodiment of this application;

FIG. 18 and FIG. 19 separately shows a schematic diagram depicting a structure of a frame carrying request information applicable to an embodiment of this application;

FIG. 20 and FIG. 21 separately shows a schematic diagram depicting a structure of a frame carrying AP coordination set information applicable to an embodiment of this application;

FIG. 22 is a schematic block diagram of an apparatus used in coordinated communication according to an embodiment of this application;

FIG. 23 is another schematic block diagram of an apparatus used in coordinated communication according to an embodiment of this application;

FIG. 24 is a schematic block diagram of a first device or a second device according to an embodiment of this application; and

FIG. 25 is a schematic block diagram of a second device or a second device according to an embodiment of this application.

### DESCRIPTION OF EMBODIMENTS

The following describes technical solutions of this application with reference to the accompanying drawings.

Embodiments of this application provide a communication method applied to a wireless communication system, so that a plurality of devices can share a time resource to perform coordinated transmission. The wireless communication system may be a wireless local area network or a cellular network. The method may be implemented by a communication device in the wireless communication system or a chip or a processor in the communication device. The communication device may be a wireless communication device in multi-device coordination. For example, the communication device may be an access point (AP) device, or a station (STA) device. For example, the communication device may alternatively be a multi-link device (MLD).

In embodiments of this application, a first device and a second device may be understood as devices for coordinated transmission. For example, both the first device and the second device may be, for example, AP devices, or both the first device and the second device may be, for example, STA devices.

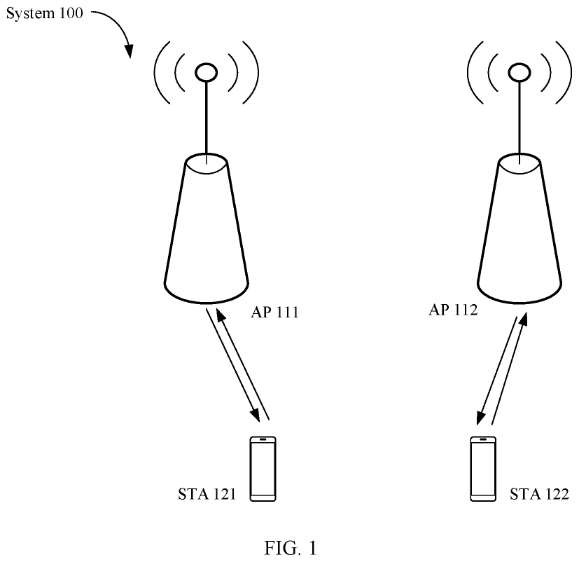

To facilitate understanding of embodiments of this application, a communication system to which an embodiment of this application is applicable is first described in detail with reference to FIG. 1.

FIG. 1 is another schematic diagram of a wireless communication system 100 applicable to an embodiment of this application. As shown in FIG. 1, the technical solutions in embodiments of this application may be applied to a wireless local area network. The wireless communication system 100 may include at least two access point devices, such as an AP 111 and an AP 112 shown in FIG. 1. The wireless communication system 100 may further include at least two station devices, such as a STA 121 and a STA 122 shown in FIG. 1. For example, the AP may be a multi-link AP, or the STA may be a multi-link STA.

One or more STAs in the station devices may communicate with one or more APs in the access point devices after establishing an association relationship. For example, the AP 111 may communicate with the STA 121. For example, the AP 111 communicates with the STA 121 after establishing an association relationship. The AP 112 may communicate with the STA 122. For example, the AP 112 communicates with the STA 122 after establishing an association relationship.

In embodiments of this application, the first device and the second device may be, for example, access point devices. For example, the first device may include the AP 111, and the second device may include the AP 111. Alternatively, the first device and the second device may be, for example, station devices. For example, the first device may include the STA 121, and the second device may include the STA 122.

It should be understood that the communication system applicable to this application described with reference to FIG. 1 is merely an example for description, and the communication system applicable to this application is not limited thereto. For example, the communication system may include more APs. For another example, the communication system may further include more STAs. For another example, embodiments of this application may be applied to a multi-device coordination scenario, for example, a multiple access points (Multi-AP) coordination scenario or a multi-station coordination scenario.

The AP device in embodiments of this application may be a device in a wireless network. The AP device may be a communication entity such as a communications server, a router, a switch, or a bridge, or the AP device may include a macro base station, a micro base station, a relay station, or the like in various forms. Certainly, the AP may alternatively be a chip, a circuit, or a processing system in the devices in various forms, to implement the methods and the functions in embodiments of this application. The AP device may be used in a plurality of scenarios, for example, a sensor node (for example, a smart water meter, a smart electricity meter, or a smart air detection node) in smart city, a smart device (for example, a smart camera, a projector, a display, a television, a stereo, a refrigerator, or a washing machine) in smart home, a node in the Internet of Things, an entertainment terminal (for example, a wearable device such as AR or VR), or a smart device in smart office (for example, a printer or a projector), an Internet of Vehicles device in the Internet of Vehicles, some infrastructure (such as a vending machine, a self-service navigation console of a shopping mall or supermarket, a self-service cashier device, and a self-service food ordering machine) in a daily life scenario, and the like.

The STA device in embodiments of this application may be a device having a wireless transceiver function, for example, may be a device that supports 802.11 series protocols and may communicate with an AP or another STA. For example, the STA is any user communication device that allows a user to communicate with an AP to communicate with a WLAN. The STA device is, for example, user equipment (UE), a mobile station (MS), a mobile terminal (MT), an access terminal, a subscriber unit, a subscriber station, a mobile station, a mobile console, a remote station, a remote terminal, a mobile device, a user terminal, a terminal, a wireless communication device, a user agent, a user apparatus, or the like.

The STA in embodiments of this application may be a device that provides a user with voice/data connectivity, for example, a handheld device or vehicle-mounted device having a wireless connection function. For example, the STA may be a mobile phone, a tablet computer, a notebook computer, a palmtop computer, a mobile internet device (MID), a wearable device, a virtual reality (VR) device, an augmented reality (AR) device, a wireless terminal in industrial control, a wireless terminal in self-driving, a wireless terminal in remote medical surgery, a wireless terminal in smart grid, a wireless terminal in transportation safety, a wireless terminal in smart city, a wireless terminal in smart home, a cellular phone, a cordless phone, a session initiation protocol (SIP) phone, a wireless local loop (WLL) station, a personal digital assistant (PDA), a hand-held device or a computing device that has a wireless communication function, or another processing device connected to a wireless modem, a vehicle-mounted device, a wearable device, a terminal device in a 5G network, a terminal device in a future evolved public land mobile network (PLMN), or the like. This is not limited in embodiments of this application.

By way of example and not limitation, in embodiments of this application, the STA device may alternatively be a wearable device. The wearable device may also be referred to as a wearable intelligent device, and is a general term of wearable devices, such as glasses, gloves, watches, clothes, and shoes, that are developed by applying wearable technologies to intelligent designs of daily wear. For example, the wearable device is a smart watch or smart glasses, and a device that focuses on only one type of application function and needs to be used together with another device such as a smartphone, for example, various smart bands and smart jewelry that monitor physical signs.

In addition, in embodiments of this application, the STA device may alternatively be a terminal device in an Internet of Things (IoT) system. IoT is an important part of future development of information technologies, and a main technical feature of IoT is to connect a thing to a network by using a communication technology, to implement an intelligent network for interconnection between a person and a machine or between one thing and another. In embodiments of this application, an IoT technology may implement massive connections, deep coverage, and terminal power saving by using, for example, a narrowband NB technology.

In addition, in embodiments of this application, the STA device may be a device in an Internet of Vehicles system. Communication modes in an Internet of Vehicles system are collectively referred to as V2X (X represents everything). For example, the V2X communication includes vehicle-to-vehicle (V2V) communication, vehicle-to-infrastructure (V2I) communication, vehicle-to-pedestrian (V2P) communication, or vehicle-to-network (V2N) communication.

In addition, in embodiments of this application, the STA device may further include a sensor in, for example, an intelligent printer, a train detector, or a gas station. Main functions of the STA device include collecting data (by some terminal devices), receiving control information and downlink data from an AP device, sending an electromagnetic wave, and transmitting data to an AP device.

In addition, the AP device in embodiments of this application may be a device configured to communicate with the STA device. The AP device may be a network device in a wireless local area network, and the AP device may be configured to communicate with the STA device by using the wireless local area network.

It should be understood that specific forms of the STA device and the AP device are not specially limited in embodiments of this application, and are merely examples for description herein.

In embodiments of this application, a specific structure of an execution body of the method provided in embodiments of this application is not specially limited, provided that a program that records code for the method provided in embodiments of this application can be run to perform communication according to the method provided in embodiments of this application. For example, the method provided in embodiments of this application may be performed by a device (for example, the AP device or the STA device), or a functional module of the device (for example, the AP device or the STA device) that can invoke and execute the program.

In addition, a computer-readable medium in this application may include but is not limited to: a magnetic storage component (for example, a hard disk, a floppy disk, or a magnetic tape), an optical disc (for example, a compact disc (CD) and a digital versatile disc (DVD)), a smart card, and a flash memory component (for example, an erasable programmable read-only memory (EPROM), a card, a stick, or a key drive). In addition, various storage media described in this specification may represent one or more devices and/or other machine-readable media that are configured to store information. The term “machine-readable media” may include but is not limited to a radio channel, and various other media that can store, contain and/or carry an instruction and/or data.

For ease of understanding of embodiments of this application, the following first briefly describes several terms in this application.

1. Multi-Link Communication

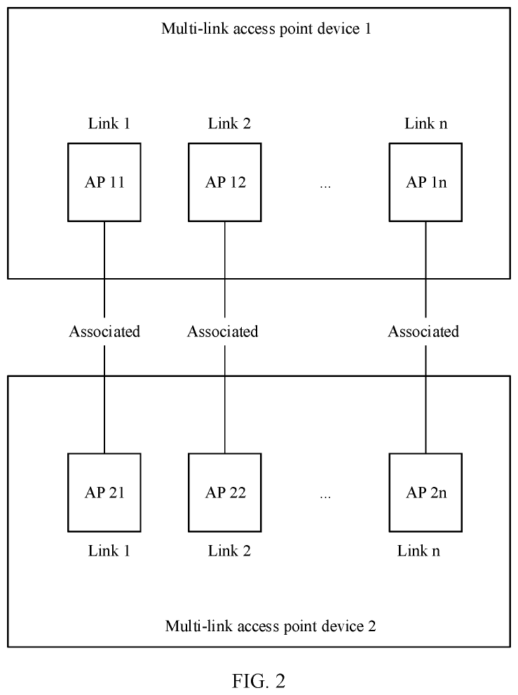

In an example, embodiments of this application may also be applied to a multi-link communication scenario. For example, the first device may be a multi-link access point device 1, and the second device may be a multi-link access point device 2. As shown in FIG. 2, it is assumed that the multi-link access point device 2 includes an AP 21, an AP 22, . . . , and an AP 2n, and the multi-link access point device 1 includes an AP 11, an AP 12, . . . , and an AP 1n, where n is an integer greater than or equal to 1. For example, the AP 21 may communicate with the AP 11 through a link 1. For another example, the AP 22 may communicate with the AP 12 through a link 2 in FIG. 2. For still another example, the AP 2n may communicate with the AP 1n through a link n in FIG. 2.

It should be understood that embodiments of this application are not limited to multi-link communication. Embodiment of this application may be applied to any multi-device coordination scenario, for example, a multi-AP coordination scenario or a multi-station coordination scenario.

2. Multi-AP Coordination

For example, a manner of multi-AP coordination may include but is not limited to coordinated orthogonal frequency division multiple access (o OFDMA) and coordinated beamforming.

Coordinated OFDMA is used as an example. For example, when a bandwidth is large, a plurality of APs may separately perform transmission on different channels in an OFDMA manner, and do not interfere with each other.

Coordinated beamforming is used as an example. For example, if the plurality of APs can obtain all channel information, interference nulling may be performed on a STA in another cell during parallel transmission, to avoid generating interference.

The foregoing manners of coordination are performed in a frequency domain and a space domain. In such manners, the plurality of APs need to be well synchronized, or channel information of a station needs to be obtained. Implementation complexity is high.

In addition, there is another manner of coordination in terms of time. In a conventional technology, the AP may share a time resource with a relay node. Specifically, after the AP sends a data frame to the relay, the relay sends the data frame to the STA in a transmit opportunity (TXOP) of the AP directly (or after sending an acknowledgment frame), so that a process of channel contention performed again by the relay may be omitted.

In the conventional technology, time resource sharing is limited to a relay scenario. In addition, the relay can only forward, to a corresponding STA, a data frame sent by the AP to the relay, and cannot freely send other data. In addition, the coordination manner is limited, and is not conducive to coordinated transmission performance.

In view of this, this application provides a method to explore a manner of multi-AP coordination in a time domain. In this way, a plurality of APs in coordinated communication can flexibly use transmission resources to perform communication, improving transmission flexibility and communication efficiency. In addition, this application further provides some preparations before multi-AP coordination, so that coordination between the plurality of APs can be more appropriate, improving coordinated transmission performance.

The following describes in detail embodiments provided in this application with reference to the accompanying drawings. In an example, a device in the following embodiments may be an AP. For example, the first device is a first AP, and the second device is a second AP. In another example, a device in the following embodiments may also be a STA. For example, the first device is a first STA, and the second device is a second STA. In other words, embodiments of this application may be applied to a multi-AP coordination scenario, a multi-station coordination scenario, or the like.

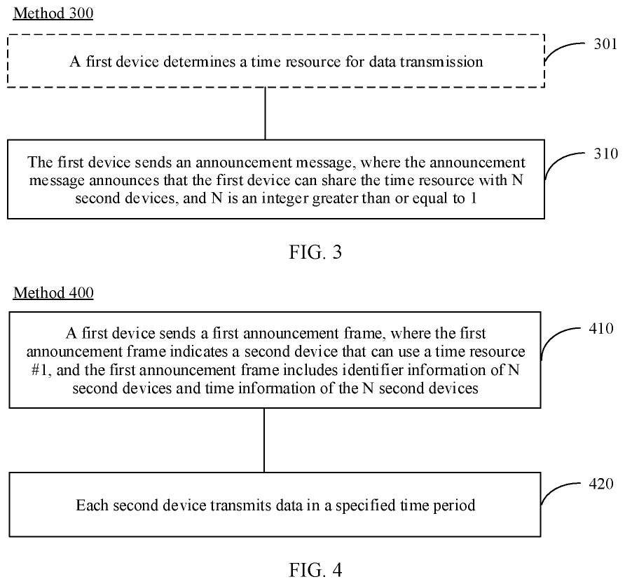

FIG. 3 is a schematic diagram of interaction in a method 300 for coordinated communication according to an embodiment of this application. The method 300 may include the following steps.

310: A first device sends an announcement message. The announcement message announces that the first device can share a time resource with N second devices, and N is an integer greater than or equal to 1.

It should be understood that the announcement message and a first announcement frame and a second announcement frame described below are names for distinguishing between different functions, and the names do not limit the protection scope of embodiments of this application. In a future protocol, all names used to represent a same function are applicable to embodiments of this application.

The first device can share the time resource with the N second devices, that is, the first device may share the time resource of the first device with another device (that is, one or more second devices). In other words, the another device may use the time resource of the first device. According to this embodiment of this application, the devices coordinate with each other in time domain. For example, the devices may share a time resource.

In the following, for differentiation, a time resource shared by the first device is denoted as a time resource #1, that is, a time resource shared by the first device with the N second devices is denoted as a time resource #1; and a channel resource shared by the first device is denoted as a channel resource #1, that is, a channel resource shared by the first device with the N second devices is denoted as a channel resource #1. This is not described in the following.

In this application, the first device may share the time resource #1, for example, a TXOP, with the N second devices. Alternatively, it may be understood that the first device may share the channel resource #1 with the N second devices.

It should be understood that, in this application, it is mentioned for a plurality of times that the second device shares the time resource #1 or the second device uses the time resource #1. Both descriptions indicate that the second device can use a part of time resources of the first device, that is, the second device can perform transmission in the part of the time resources. Certainly, the second device may also use all time resources of the first device. For example, when the first device does not transmit data, the second device may use all time resources of the first device. It may be understood that the time resource #1 may be a part of time resources of the first device, or may be all time resources of the first device. This is not limited herein. This is not described in the following.

It should be further understood that, in this application, it is mentioned for a plurality of times that the second device shares the channel resource #1 or the second device uses the channel resource #1. Both descriptions indicate that the second device may use a part of channel resources of the first device, that is, the second device may use the part of the channel resources for transmission. Certainly, the second device may also use all channel resources of the first device. This is not limited herein. It may be understood that the channel resource #1 may be a part of channel resources of the first device, or may be all channel resources of the first device. This is not limited herein. This is not described in the following.

In this application, a sharing device is denoted as the first device, that is, the first device represents a sharing device, and the first device may be, for example, a sharing AP. A shared device is denoted as the second device, that is, the second device represents a shared device, and the second device may be, for example, a shared AP. This is not described in the following.

Optionally, before step 310, the method 300 may further include step 301.

301: The first device determines a time resource for data transmission.

That is, the first device obtains a time resource for data transmission, and the first device may use a channel resource based on the obtained time resource. The time resource may be, for example, an allocated time resource, or may be a time resource obtained in a channel contention manner.

It should be understood that how the first device obtains the time resource is not limited in this embodiment of this application.

In a possible implementation, the first device may obtain a transmit opportunity (TXOP) in a channel contention manner. For example, after contending for a channel, the first device may send the announcement message to the N second devices.

Optionally, an occasion for sending the announcement message by the first device is not limited in this embodiment of this application.

In an example, the first device may send the announcement message after obtaining the time resource.

For example, the first device may send the announcement message after obtaining the TXOP through channel contention. The announcement message announces that the first device can share the TXOP with the N second devices. In other words, the first device may share the TXOP of the first device with the N second devices, reducing overheads caused by channel contention performed again by another AP (that is, the second AP), and improving resource utilization.

In another example, the first device may first transmit data after obtaining the time resource, and then send the announcement message after the data transmission completes.

For example, the first device may first transmit data after obtaining the TXOP through channel contention, and then sends the announcement message after the data transmission completes. The announcement message announces that the first device can share the TXOP with the N second devices. In other words, the first device may share an unused part of the TXOP with the N second devices. This can not only ensure data transmission of the first device, but also reduce overheads caused by channel contention performed again by another device (that is, the second device). The second device can perform communication on an unused resource, improving resource utilization.

It should be understood that a specific occasion for sending the announcement message is not limited in this embodiment of this application.

Based on this embodiment of this application, when the first device shares the time resource with the N second devices, an appropriate transmission resource may be allocated to each second device in advance. In this way, each second device may perform transmission on a transmission resource corresponding to each second device, improving data transmission performance of each second device. In addition, each second device may directly send data to a STA, so that the transmission resource can be flexibly used, transmission latency can be reduced, flexibility of data transmission can be improved, and resource utilization can be improved.

In this embodiment of this application, the announcement message announces that the first device can share the time resource with the N second devices. It should be understood that the N second devices herein may be specifically the N second devices, or may be N second devices in general. This is not limited herein. The following describes the two possible solutions.

Optionally, that the first device can share the time resource with the N second devices includes at least the following two solutions.

Solution A: The announcement message includes an identifier of the second device or a group identifier of a group to which the second device belongs.

For example, the first device knows which second devices need to share the time resource. Therefore, the announcement message sent by the first device includes the identifier of the second device or the group identifier of the group to which the second device belongs.

Solution B: The announcement message includes indication information, and the indication information indicates the N second devices to perform channel contention.

For example, the first device does not know which second devices need to share the time resource. Therefore, the announcement message sent by the first device includes the indication information, indicating that the N second devices may transmit data in a channel contention manner in the transmit opportunity shared by the first device. In this solution, the first device does not need to know a transmission requirement of the second device, and does not need to carry information about the second device in the announcement message. Signaling overheads are low, and transmission efficiency is high.

The following describes the solution A and the solution B in detail.

First, the solution A is described with reference to a method 400 shown in FIG. 4. The method 400 may include the following steps.

410: A first device sends a first announcement frame. The first announcement frame indicates a second device that can use a time resource #1, and the first announcement frame includes identifier information of N second devices and time information of the N second devices.

It may be understood that the announcement message is carried in the announcement frame. The first announcement frame is similar to the announcement message in the method 300. In the method 400, the announcement message is carried in the first announcement frame. For differentiation, an announcement frame in the solution A is denoted as a first announcement frame, and an announcement frame in the solution B is denoted as a second announcement frame.

In this application, the first announcement frame indicates a second device that can use the time resource #1, and the second announcement frame indicates that a second device may transmit data in a channel contention manner on the time resource #1 (for example, in a transmit opportunity shared by the first device). The first announcement frame is first described with reference to the solution A in the method 400.

In an example, the first device may send the first announcement frame after obtaining the time resource (for example, the TXOP).

In another example, the first device may first transmit data after obtaining the time resource (for example, the TXOP), and send the first announcement frame after the data transmission completes.

It should be understood that, for a specific occasion for sending the first announcement frame by the first device, reference may be made to the foregoing occasion for sending the announcement message. This is not limited in this embodiment of this application.

(1) The first announcement frame includes the identifier information of the N second devices.

Optionally, the identifier information of the N second devices may include an identifier (ID) of each second device; or the identifier information of the N second devices may include a group identifier (group ID) of a group to which the second device belongs. It may be understood that one second device group may include a plurality of second devices.

In this embodiment of this application, the first device carries, in the sent first announcement frame, the identifier of the second device or the group identifier of the group to which the second device belongs, so that another device can determine, based on whether an identifier of the another device or a group identifier of a group to which the another device belongs is in the first announcement frame, whether the another device can use the time resource #1.

In a possible implementation, the first announcement frame includes an identifier of each second device. For example, the first announcement frame includes a list of identifiers of the N second devices.

In this way, each second device may determine, based on an identifier of the second device, whether the time resource #1 can be used. For example, if a device finds that an identifier of the device is not in the first announcement frame, the device cannot use the time resource #1. For example, the device may sleep in a time period (that is, the time resource #1) shared by the first device. For another example, if a device finds that an identifier of the device is in the first announcement frame, the device can use the time resource #1.

In another possible implementation, the first announcement frame includes a group identifier of a group to which the second device belongs. For example, the first announcement frame includes one or more group identifiers, and the one or more group identifiers are used to identify the N second devices.

In this way, each second device may determine, based on the group identifier of the group to which the second device belongs, whether the time resource of the first device can be used. For example, if a device finds that a group identifier of a group to which the device belongs is not in the first announcement frame, the device cannot use the time resource #1. For example, the device may sleep in a time period (that is, the time resource #1) shared by the first device. For another example, if a device finds that a group identifier of a group to which the device belongs is in the first announcement frame, the device can use the time resource #1.

(2) The first announcement frame may include the time information of the N second devices.

Optionally, the time information includes one or more of the following: duration of using by each second device, start time of using the channel resource #1 by each second device, and end time of using the channel resource #1 by each second device.

The time information of the second device is carried in the first announcement frame, so that the second device can transmit data in a time period corresponding to the second device.

In an example, the first announcement frame may include duration of using by each second device. The duration of using by the second device is maximum duration in which the second device can use the channel resource #1, or is referred to as maximum transmission duration. Duration of actually using the channel resource #1 by the second device does not exceed the maximum duration, or the duration of actually using the channel resource #1 by the second device is less than or equal to the maximum duration. It should be understood that duration of using by each second device may be the same or may be different. This is not limited herein.

In another example, the first announcement frame may include the start time of using the channel resource #1 by the second device. The start time of using the channel resource #1 by the second device indicates time at which the second device starts to use the channel resource #1. That is, the second device may start to use the channel resource #1 at the start time of using the channel resource #1.

Optionally, the first announcement frame may further include channel information of each second device and/or sequence information of the N second devices. Descriptions are separately provided below.

(1) Channel Information of the Second Device

The channel information of the second device indicates a channel resource that can be used by the second device. The channel information of the second device is carried in the first announcement frame, so that the second device can transmit data on a channel resource shared by the first device with the second device.

For example, the channel information of the second device may include one or more of the following: an identifier of a link that can be used by the second device and an identifier of a channel that can be used by the second device.

In an example, the first announcement frame may include an identifier of a link that can be used by each second device. For example, when the first device obtains TXOPs on a plurality of links, the first announcement frame may carry an identifier of a link that can be used by each second device. Links that may be used by all second devices may be the same or may be different. Alternatively, links that may be used by the second device may be the same as or may be different from a plurality of links used by the first device. This is not limited herein.

(2) Sequence Information of the N Second Devices

The sequence information of the N second devices indicates a sequence of using the time resource #1 by the N second devices. The N second devices may determine, based on the sequence information, the sequence of using the time resource #1.

Optionally, there are many manners of using the time resource #1 by each second device. This is not limited in this embodiment of this application.

In an example, the first announcement frame may include the sequence information of the N second devices, to indicate the sequence of using the time resource #1 by the N second devices. The N second devices may determine, based on the sequence information, the sequence of using the time resource #1.

In another example, the second device may determine a sequence of using the time resource #1 based on a sequence in which the identifiers appear.

For example, the first announcement frame includes an identifier of each second device, and the second device determines, based the sequence in which the identifiers of the second devices appear in the first announcement frame, the sequence of using the time resource #1 by the second device. For example, the time resource #1 is sequentially used based on the sequence in which the identifiers appear. In still another example, the first announcement frame includes a group identifier, and the group identifier may indicate a sequence of the N second devices.

It should be understood that the foregoing is merely an example for description, and this embodiment of this application is not limited thereto. For example, it may be predefined that a sequence of using the time resource #1 by the N second devices one-to-one corresponds with the identifiers of the N second devices. For example, the time resource #1 may be sequentially used based on values of the identifiers of the second devices, for example, in a descending order or an ascending order of the identifiers.

The foregoing example describes content that may be included in the first announcement frame. It should be understood that the first announcement frame may further include more content, for example, bandwidth. This is not limited herein.

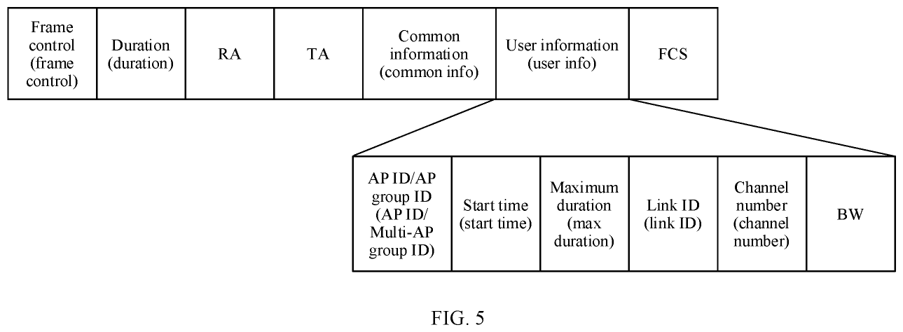

A specific form of the first announcement frame is not limited in this embodiment of this application. With reference to a possible frame structure shown in FIG. 5, the following describes a possible frame structure applicable to the first announcement frame by using an example.

For example, as shown in FIG. 5, the frame structure may include but is not limited to frame control, duration, a receiver address (RA), a transmitter address (TA), common information (common info), user information (user info), and a frame check sequence (FCS).

For example, the user information may include but is not limited to an identifier (for example, an AP ID) of the second device or a group identifier (for example, a Multi-AP group ID) of a group to which the second device belongs, start time, max duration, a link identifier (link ID), a channel number, and bandwidth (BW).

The start time indicates time at which the second device can start to use the channel resource shared by the first device with the second device. In addition, one multi-AP group may include a plurality of APs.

420: Each second device transmits data in a specified time period.

That is, each second device may perform, based on the time information in the first announcement frame, communication on a time resource allocated by the first device to each second device.

In the embodiment of the method 400, the second device may transmit data in a corresponding time period based on the first announcement frame. For example, if the first announcement frame carries the time information of the second device, for example, start time and duration of using a channel, the second device may transmit data in a corresponding time period based on the start time and the duration that are indicated in the first announcement frame.

For example, if the first device knows which second devices need to share the time resource #1, the solution described in the method 400 may be used.

Based on the foregoing solution, a plurality of devices may share a time resource. For example, the first device may send an announcement frame (that is, the first announcement frame), and the first announcement frame may indicate a second device that can share a time resource with the first device, so that sharing of the time resource between the plurality of devices can be implemented. In this way, coordination between the plurality of devices can be implemented, and another device does not need to perform channel contention again, and can perform communication on a resource allocated by the first device to each second device. This can reduce overheads caused by channel contention performed again by the another device. In addition, in this embodiment of this application, the plurality of AP devices may directly send data to a STA, so that data can be transmitted freely, transmission latency can be reduced, and flexibility of data transmission can be improved.

The foregoing describes the solution A with reference to FIG. 4 and FIG. 5, and the following describes the solution B.

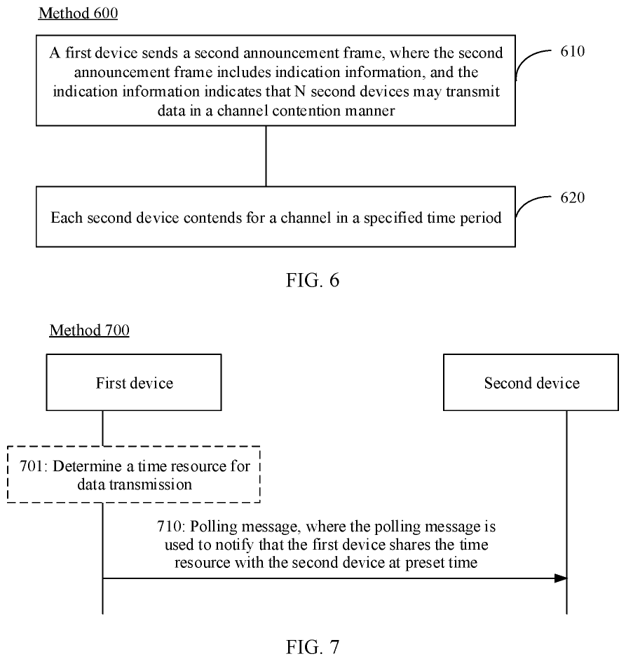

The following describes the solution B with reference to a method 600 shown in FIG. 6. The method 600 may include the following steps.

610: A first device sends a second announcement frame. The second announcement frame includes indication information, and the indication information indicates that N second devices may transmit data in a channel contention manner.

It may be understood that the first device sends the indication information. The indication information may be carried in the second announcement frame, and the indication information indicates that the N second devices may transmit data in a time resource #1 (for example, in a transmit opportunity shared by the first device) in a channel contention manner.

For differentiation, the indication information is denoted as indication information #1. It may be understood that the announcement message is carried in the announcement frame. The second announcement frame is similar to the announcement message in the method 300. In the method 600, the announcement message is carried in the second announcement frame.

After receiving the second announcement frame, the second device may perform channel contention starting from specified time by using a specified channel contention parameter, and transmit data after the channel contention succeeds.

The second announcement frame may include time information of the N second devices. For example, the second announcement frame includes one or more of the following: duration of channel contention of each second device, start time of channel contention of each second device, and end time of channel contention of each second device.

In this application, the second announcement frame is similar to the first announcement frame. A difference lies in that the time information (that is, the time information of the N second devices) in the first announcement frame indicates time information for using the channel resource #1 by the second device, and the time information (that is, the time information of the N second devices) in the second announcement frame indicates time information for performing channel contention by the second device.

Optionally, the second announcement frame may include sequence information of the N second devices, and the sequence information of the N second devices indicates a sequence of starting channel contention by the N second devices. The N second devices may determine the sequence of channel contention based on the sequence information.

It may be understood that the second announcement frame in the method 600 is similar to the first announcement frame in the method 400. A difference lies in that the time information of the first announcement frame indicates time information for using the channel resource #1 by the second device in the method 400; and the time information of the second announcement frame indicates time information for performing channel contention by the second device in the method 600. In addition, for content (such as the sequence information) included in the second announcement frame and a frame structure of the second announcement frame, refer to the descriptions of the first announcement frame in the method 400. Details are not described herein again.

The following describes a possible form of the indication information #1.

In a possible implementation, the indication information #1 may be a preset ID, for example, marked as a special AP ID. The preset ID may be, for example, pre-specified, or may be pre-agreed on. This is not limited herein.

For example, it is assumed that the indication information #1 is carried in the second announcement frame. When identifier information of the N second devices in the second announcement frame is a specific value (that is, the preset ID), devices (that is, the N second devices) that belong to a same device coordination set (for example, an AP coordination set) as the first device may transmit data in a channel contention manner. Alternatively, it may be understood that when the identifier information of the N second devices in the second announcement frame is the preset ID, all devices that are in the same device coordination set as the first device may transmit data in a channel contention manner.

The device coordination set (for example, the AP coordination set) is a set including a plurality of devices. Devices belonging to a same device coordination set may coordinate with each other, that is, initiate coordinated transmission with each other. There are many manners of establishing the device coordination set. For example, the device coordination set may be preconfigured by using software, or may be established in another process. This is not limited in this embodiment of this application.

Optionally, the indication information #1 may further include group identifier information of a device coordination set, indicating that all devices in a corresponding device coordination set can transmit data in a channel contention manner.

In another possible implementation, the indication information #1 may include transmission mode information and an ID of each second device.

The transmission mode information may indicate whether the second AP transmits data in a channel contention manner. For example, the transmission mode information may indicate whether the second device can transmit data in a channel contention manner. For another example, the transmission mode information may indicate whether the second device needs to transmit data in a channel contention manner. The transmission mode information may be used together with an identifier of the second device, that is, the transmission mode information indicates whether each second device can transmit data in a channel contention manner.

For example, values of a field carrying the transmission mode information may be a first value and a second value. When the value of the field is the first value, it indicates no need of contention, that is, the second device does not need to transmit data in a channel contention manner. When the value of the field is the second value, it indicates a need of contention, that is, the second device needs to transmit data in a channel contention manner.

Optionally, the first device may further send parameter information to the second device. The parameter information includes a channel contention parameter used by the second device when the second device performs, through channel contention, data transmission in a time period of the transmit opportunity shared by the first device. The parameter information and the indication information #1 may be carried in same signaling, or may be sent to the second device by using separate signaling. This is not limited herein.

For example, the parameter information may include but is not limited to a minimum contention window (CWmin), a maximum contention window (CWmax), or an arbitrary inter-frame space (AIFS).

620: Each second device contends for a channel in a specified time period.

For example, each second device contends, based on the time information in the second announcement frame, for a channel on a time resource allocated by the first device to each second device. For another example, each second device performs channel contention based on the channel contention parameter indicated by the first device.

After successfully contending for a channel, the second device may transmit data.

For example, if the first device does not know which second devices need to share the time resource #1, the solution described in the method 600 may be used.

Based on the foregoing solution, a plurality of devices may share a time resource. For example, the first device may send the second announcement frame, and the second announcement frame carries the indication information (that is, the indication information #1). The indication information #1 may indicate that a second device can transmit data in a channel contention manner, and each second device may transmit data in a time period corresponding to each second device through channel contention. In this way, coordination between a plurality of devices can be implemented, and the plurality of devices may also directly send data to a STA. This can reduce transmission latency, improve flexibility of transmission, and improve resource utilization.

FIG. 7 is a schematic diagram of interaction in a method 700 for coordinated communication according to another embodiment of this application. The method 700 may include the following steps.

710: A first device sends a polling message to a second device. The polling message is used to notify that the first device shares a time resource with the second device at preset time.

It should be understood that the polling message and a first polling frame and a second polling frame described below are names for distinguishing between different functions, and the names do not limit the protection scope of embodiments of this application. In a future protocol, all names used to represent a same function are applicable to embodiments of this application.

In this embodiment of this application, one second device may be scheduled in one polling. Therefore, the polling message may carry an identifier of a second device, to indicate that the second device is scheduled.

The following describes the polling message in detail.

Optionally, before step 710, the method 700 may further include step 701.

701: The first device determines a time resource for data transmission.

That is, the first device obtains a time resource for data transmission, and the first device may use a channel resource based on the obtained time resource. The time resource may be, for example, an allocated time resource, or may be a time resource obtained in a channel contention manner.

It should be understood that how the first device obtains the time resource is not limited in this embodiment of this application.

In a possible implementation, the first device may obtain a TXOP in a channel contention manner. For example, after contending for a channel, the first device may separately send a polling message to each second device.

Optionally, an occasion for sending the polling message by the first device is not limited in this embodiment of this application.

In an example, the first device may send the polling message after obtaining the time resource.

For example, the first device may send the polling message after obtaining the TXOP through channel contention. The polling message indicates the first device to share the TXOP with the second device at the preset time. In other words, the first device may share the TXOP of the first device with the second device, reducing overheads caused by channel contention performed again by another device (that is, the second device).

In another example, the first device may first transmit data after obtaining the time resource, and then send the polling message after the data transmission completes.

For example, the first device may first transmit data after obtaining the TXOP through channel contention, and then send the polling message after the data transmission completes. The polling message indicates the first device to share the TXOP with the second device at the preset time. That is, the first device may share an unused part of the TXOP with N second devices. This can not only ensure data transmission of the first device, but also reduce overheads caused by channel contention performed again by another device (that is, the second device).

It should be understood that a specific occasion for sending the polling message is not limited in this embodiment of this application.

The polling message is used to notify that the first device shares the time resource with the second device at the preset time. That is, when the first device shares a time resource #1 with a second device, the first device may send a polling message to the second device, to notify the second device to share the time resource #1 at preset time. In this embodiment of this application, the first device can share the time resource #1 with the N second devices, and the first device may separately send a polling message to each second device, to notify each second device to share the time resource of the first device at preset time corresponding to each second device.

Based on this embodiment of this application, when sharing a time resource with the N second devices, the first device may allocate an appropriate transmission resource to each second device in a dynamic or real-time manner based on a data transmission status of each second device. Therefore, each second device can perform transmission on a transmission resource allocated by the first device. This can further improve resource utilization, and reduce resource waste.

Optionally, that the polling message is used to notify that the first device shares a time resource with the second device at preset time includes at least the following two solutions.

Solution C: The polling message is used to notify the second device to use, at the preset time, the channel resource shared by the first device with the second device.

For example, the first device knows which second devices need to share the time resource, and the polling message sent by the first device is used to notify the second device to use, at the preset time, the channel resource shared by the first device with the second device.

Solution D: The polling message is used to notify the second device to start channel contention at the preset time.

For example, the first device does not know which second devices need to share the time resource, and the polling message sent by the first device is used to notify the second device to start channel contention at the preset time.

The following describes the solution C and the solution D in detail.

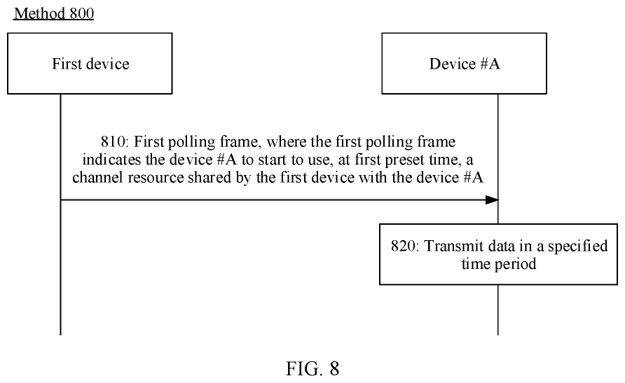

The following describes the solution C with reference to a method 800 shown in FIG. 8. The method 800 may include the following steps.

810: A first device sends a first polling frame to a device #A. The first polling frame indicates the device #A to start to use, at first preset time, a channel resource shared by the first device with the device #A.

In this embodiment of this application, one second device may be scheduled in one polling. Therefore, the first polling frame may carry an identifier of the device #A, to indicate that the device #A is scheduled. For example, the identifier of the device #A may be carried in a receiver address RA, for example, a media access control (MAC) address. This is not limited herein.

It should be understood that the first polling frame is merely a name for distinguishing between different functions, and does not limit the protection scope of embodiments of this application. For differentiation, a polling frame in the solution C is denoted as a first polling frame, and a polling frame in the solution D is denoted as a second polling frame.

In this application, the first polling frame indicates the second device to start to use, at the first preset time, the channel resource shared by the first device with the second device, and the second polling frame indicates the second device to start channel contention at second preset time, and data transmission may be performed after the channel contention succeeds. First, the first polling frame is described with reference to the solution C described in the method 800.

In this application, the device #A belongs to N second devices. It should be understood that the device #A is merely a name with generality, and does not limit the protection scope of embodiments of this application.

Optionally, that the first polling frame indicates a second device (for example, the device #A) to start to use, at the first preset time, the channel resource shared by the first device with the second device includes at least the following two possible implementations.

Manner 1: The first polling frame indicates the second device to start to use, after first preset duration, the channel resource shared by the first device with the second device.

In an example, the first preset duration may be preconfigured or predefined duration, for example, a short inter-frame space (SIFS). In this case, the first polling frame may not need to carry information about the first preset duration. The device #A is used as an example. For example, the device #A starts timing when receiving the first polling frame, and starts to use, after the first preset duration, the channel resource shared by the first device with the device #A.

In another example, the first preset duration may be duration configured by the first device for the second device. In this case, the first polling frame may carry information about the first preset duration. The device #A is used as an example. For example, the first polling frame carries the information about the first preset duration. The device #A starts timing when receiving the first polling frame, and starts to use, after the first preset duration, the channel resource shared by the first device with the device #A.

Manner 2: The first polling frame indicates the second device to start to use, at a first preset moment, the channel resource shared by the first device with the second device.

In an example, the first preset moment may be a preconfigured or predefined moment. In this case, the first polling frame may not need to carry information about the first preset moment. The device #A is used as an example. For example, after receiving the first polling frame, the device #A starts to use, at the first preset moment, the channel resource shared by the first device with the device #A.

In a possible design, the first preset moment is a moment at which the first polling frame is received. That is, after receiving the first polling frame, the second device starts to use the channel resource shared by the first device with the second device.

In another example, the first preset moment may be a moment configured by the first device for the second device. In this case, the first polling frame may carry information about the first preset moment. The device #A is used as an example. For example, after receiving the first polling frame, the device #A starts to use, at the first preset moment, the channel resource shared by the first device with the device #A.

The foregoing describes the two manners as an example. This is not limited in this embodiment of this application. A manner in which the second device can determine, based on the first polling frame, to start to use the channel resource shared by the first device with the second device is applicable to this embodiment of this application.

In addition, in this embodiment of this application, the first polling frame may carry time information. For example, the first polling frame may carry information about maximum duration in which the second device (for example, the device #A) can use the channel resource #1, and/or the first polling frame may carry information about the first preset duration or the first preset moment. For example, the time information may be carried in a duration field in the first polling frame.

Optionally, the first polling frame may also carry a link identifier and/or a channel number, that is, a link and a channel that can be used by the second device.

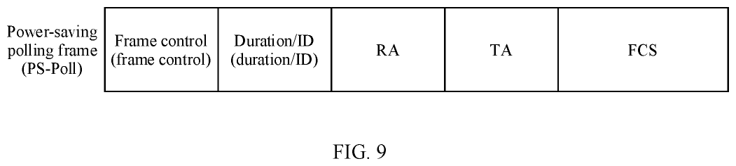

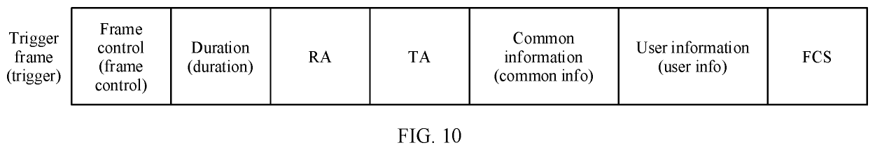

A specific form of the first polling frame is not limited in this embodiment of this application. With reference to possible frame structures shown in FIG. 9 and FIG. 10, the following describes a possible frame structure applicable to the first polling frame by using an example.

In a possible design, a frame structure of a power-saving polling (PS-Poll) frame may be reused. For example, as shown in FIG. 9, the frame structure may include but is not limited to frame control, duration (or length of duration)/identifier (ID), a receiver address (RA), a transmitter address (TA0, and a frame check sequence (FCS).

In another possible design, a frame structure of a trigger frame may be reused. For example, as shown in FIG. 10, the frame structure may include but is not limited to frame control, a duration field, a receiver address (RA), a transmitter address (TA), common information, user information, and a frame check sequence FCS.

It should be understood that the frame structures shown in FIG. 9 and FIG. 10 are merely examples for description, and any variation of the structures falls within the protection scope of embodiments of this application.

820: The device #A transmits data in a specified time period.

In the embodiment of the method 800, each second device may transmit data in a corresponding time period based on the first polling frame. The device #A is used as an example. For example, the device #A receives the first polling frame from the first device, and the first polling frame indicates the device #A to start to use, at the first preset time, the channel resource shared by the first device with the device #A, so that the device #A may start to use, at the first preset time, the channel resource shared by the first device with the device #A. For details, refer to the foregoing manner 1 or manner 2.

Optionally, if maximum transmission duration allocated (or granted) to the second device is not used up, the first device or another second device is notified in any one of the following processing manners.

Processing manner 1: The second device sends a return frame to the first device.

It should be understood that the return frame is merely a name for distinguishing between different functions, and does not limit the protection scope of embodiments of this application. In a future protocol, all names used to represent a same function fall within the protection scope of embodiments of this application.

The second device sends a return frame to the first device, and the return frame is used to return a remaining time resource in the time resource allocated by the first device to the device #A. After receiving the return frame, the first device may continue to send a first polling frame to a next second device, to indicate that the next second device may start to use, at first preset time, a channel resource shared by the first device with the next second device. For the first preset time, refer to the foregoing description.

The following uses the device #A as an example to describe the foregoing processing manner 1.

If the maximum transmission duration allocated to the device #A is not used up, the device #A may send a return frame to the first device. The return frame is used to return a remaining time resource of the time resource allocated by the first device to the device #A.

Optionally, if the device #A has no data to be transmitted, the device #A may directly send the return frame to the first device.

Optionally, after receiving the return frame sent by the device #A, the first device may continue to send the first polling frame to a device #B, to indicate that the device #B may start to use, at the first preset time, the channel resource shared by the first device with the device #B. The device #B may be a next second device, that is, a second device that can use the channel resource #1 after the device #A.

A specific form of the return frame is not limited in this embodiment of this application.

In a possible design, the return frame may be a quality of service (QoS) null (QoS Null frame). For example, a receiver address RA of the return frame may be set to a broadcast address, and a more data field in a frame control field of the return frame may be set to 0.

In addition, the first device may determine, in the foregoing processing manner 1, that data transmission of the second device completes. That is, the first device receives the return frame from the second device, and determines, based on the return frame, that data transmission of the second device completes.

Processing manner 2: The second device sends a transfer frame to a next second device.

It should be understood that the transfer frame is merely a name for distinguishing between different functions, and does not limit the protection scope of embodiments of this application. In a future protocol, all names used to represent a same function fall within the protection scope of embodiments of this application.

The second device sends a transfer frame to a next second device, and the transfer frame is used to transfer a remaining time resource of the time resource allocated by the first device to the second device. After receiving the transfer frame, the next second device may directly perform transmission.

In this embodiment of this application, a time period that is not used up by a second device may be postponed to a next second device for use. For example, a time period that is not used up by the device #A may be postponed to the device #B for use.

Optionally, the first polling frame may also carry indication information. For example, the indication information is denoted as indication information #2, and the indication information #2 indicates whether a second device can use a time period that is not used up by a previous second device. For example, if the indication information #2 carried in the first polling frame indicates that a second device can use a time period that is not used up by a previous second device, the device #B may use the time period that is used up by the device #A. For another example, if the indication information #2 carried in the first polling frame indicates that a second device cannot use a time period that is not used up by a previous second device, the device #B cannot use the time period that is used up by the device #A.

A specific form of the transfer frame is not limited in this embodiment of this application.

In a possible design, the transfer frame may be a QoS null frame. For example, a receiver address RA of the transfer frame may be set to a broadcast address, and a more data field in frame control of the transfer frame may be set to 0.

Processing manner 3: The second device may send indication information #3, to indicate to return an unused part of the transmit opportunity.

In a possible implementation, the second device sends the indication information #3 to the first device. After receiving the indication information #3, the first device may continue to send a first polling frame to a next second device, to indicate that the next second device may start to use, at first preset time, a channel resource shared by the first device with the next second device. For the first preset time, refer to the foregoing description.

In another possible implementation, the second device sends the indication information #3 to a next second device. After receiving the indication information #3, the next second device may directly perform transmission.

In addition, the first device may determine, in processing manner 3, that data transmission of the second device completes. In other words, the first device determines, based on the indication information #3 sent by the second device, that data transmission of the second device completes.

The following uses the device #A as an example to describe the foregoing processing manner 3.

For example, the device #A may carry indication information #3 in a last data frame, to indicate that data transmission of the device #A completes. For another example, the device #A may carry indication information #3 in a last trigger frame, to indicate that data transmission of the device #A completes.

Optionally, a specific indication method may be any combination of the following methods.

Method 1: The device #A sets a value of a more data subfield in a frame control field of a last data frame to 0.

For example, the first device may determine, based on the more data field in the data frame, that data transmission of the device #A completes.

In an example, if the value of the more data field in the last data frame transmitted by the device #A is 0, the first device may consider that data transmission of the device #A completes. The first device may send the first polling frame to the device #B, to indicate that the device #B may start to use, at the first preset time, the channel resource shared by the first device with the device #B.

Method 2: The device #A sets a value of a more fragment subfield in a frame control field of a last data frame to 1.

For example, the first device may determine, based on the more fragment field in the frame control field of the data frame, that data transmission of the device #A completes.

In an example, if the value of the more fragment field in the frame control field of the last data frame transmitted by the device #A is 1, the first device may consider that data transmission of the device #A completes. The first device may send the first polling frame to the device #B, to indicate that the device #B may start to use, at the first preset time, the channel resource shared by the first device with the device #B.

Method 3: The device #A sets a value of an end of service period (EOSP) subfield in a quality of service control (QoS control) field of a last data frame to 1.

For example, the first device may determine, based on the EOSP field in the QoS control field of the data frame, that data transmission of the device #A completes.

In an example, if the value of the EOSP field in the QoS control field of the last data frame transmitted by the device #A is 1, it indicates that a service period (SP) expires, and the first device may consider that data transmission of the device #A completes. The first device may send the first polling frame to the device #B, to indicate that the device #B may start to use, at the first preset time, the channel resource shared by the first device with the device #B.

Method 4: The device #A sets a value of a duration field of a last data frame to 0, or sets to a sum of a short inter-frame space (SIFS) and a length of a BA (that is, the sum of the SIFS and a value of the BA).

For example, the first device may determine, based on the value of the duration field of the data frame, that data transmission of the device #A completes.

In an example, if the value of the duration field in the last data frame transmitted by the device #A is 0, the first device may consider that data transmission of the device #A completes. The first device may send the first polling frame to the device #B, to indicate that the device #B may start to use, at the first preset time, the channel resource shared by the first device with the device #B.

In another example, if the value of the duration field in the last data frame transmitted by the device #A is less than or equal to a value of (SIFS+BA), the first device may consider that data transmission of the device #A completes. The first device may send the first polling frame to the device #B, to indicate that the device #B may start to use the channel resource shared by the first device with the device #B.

Method 5: The device #A sets a value of a more trigger frame field of a last trigger frame to 0.

For example, the first device may determine, based on the more TF field in the last trigger frame transmitted by the device #A, that data transmission of the device #A completes.

In an example, if the value of the more TF field in the last trigger frame transmitted by the device #A is 0, the first device may consider that data transmission of the device #A completes. The first device may send the first polling frame to the device #B, to indicate that the device #B may start to use, at the first preset time, the channel resource shared by the first device with the device #B.

It should be understood that the foregoing several methods are merely examples for description. This is not limited in this embodiment of this application. Any method that can enable the first device to determine whether data transmission of the second device completes can be used in this embodiment of this application.

It should be further understood that a solution in which the first device determines whether data transmission of the second device completes may be used independently, or may be used in combination with the solution in the method 800.

For example, if the first device knows which second devices need to share the time resource #1, the solution described in the method 800 may be used.

The foregoing describes the solution C by using an example with reference to FIG. 8 to FIG. 10. In this embodiment of this application, a plurality of devices may share a time resource. For example, the first device may send a polling frame (that is, the first polling frame), and the first polling frame indicates the second device to start to use, at the preset time, the channel resource shared by the first device with the second device, so that the time resource can be shared between the plurality of devices. In this way, coordination between the plurality of devices can be implemented, and another device does not need to perform channel contention again. This can reduce overheads caused by channel contention performed again by the another device. In addition, in this embodiment of this application, the plurality of devices may directly send data to a STA, so that data can be transmitted freely, transmission latency can be reduced, and flexibility of data transmission can be improved.

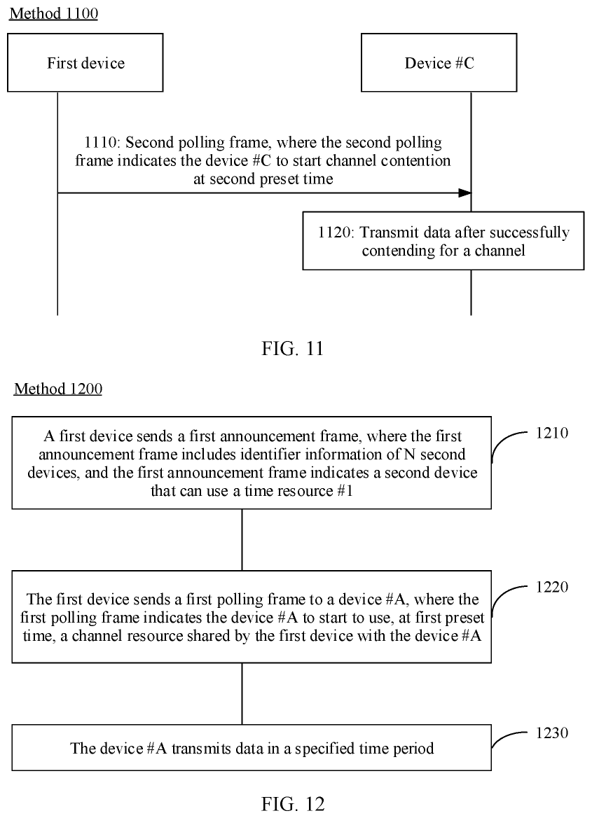

The following describes the solution D with reference to a method 1100 shown in FIG. 11. The method 1100 may include the following steps.

1110. A first device sends a second polling frame to a device #C. The second polling frame indicates the device #C to start channel contention at second preset time.

Optionally, the second polling frame may carry indication information (that is, indication information #1), and the indication information indicates that N second devices may transmit data in a channel contention manner.

In this application, the device #C belongs to the N second devices. It should be understood that the device #C is merely a name with generality, and does not limit the protection scope of embodiments of this application.

It may be understood that a polling message is carried in a polling frame, and the second polling frame is similar to the polling message in the method 700. In the method 1100, the polling message is carried in the second polling frame.

After receiving the second polling frame, the device #C may start channel contention at specified time by using a specified channel contention parameter, and transmit data after the channel contention succeeds.

In this application, the first polling frame indicates the second device to start to use, at the first preset time, the channel resource shared by the first device with the second device, and the second polling frame indicates the second device to start channel contention at second preset time, and data transmission may be performed after the channel contention succeeds. The following describes the second polling frame with reference to the solution D described in the method 1100.

The second polling frame in the method 1100 is similar to the first polling frame in the method 800. A difference lies in that the time information of the first polling frame indicates time information for starting to use the channel resource #1 by the second device in the method 800; and the time information of the second polling frame indicates time information for starting channel contention by the second device in the method 1100. In addition, for content included in the second polling frame and a frame structure of the second polling frame, refer to the description about the first polling frame in the method 800. Details are not described herein again.

That the second polling frame indicates the second device (for example, the device #C) to start channel contention at the second preset time includes at least the following two possible implementations.

Manner 1: The second polling frame indicates the second device to start channel contention after second preset duration.

In an example, the second preset duration may be preconfigured or predefined duration. In this case, the second polling frame may not need to carry information about the second preset duration. The device #C is used as an example. For example, the device #C starts timing when receiving the second polling frame, and starts channel contention after the second preset duration.

In another example, the second preset duration may be duration configured by the first device for the second device. In this case, the second polling frame may carry information about the second preset duration. The device #C is used as an example. For example, the second polling frame carries information about the second preset duration. The device #C starts timing when receiving the second polling frame, and starts channel contention after the second preset duration.

Manner 2: The second polling frame indicates the second device to start channel contention at a second preset moment.

In an example, the second preset moment may be a preconfigured or predefined moment. In this case, the second polling frame may not need to carry information about the second preset moment. The device #C is used as an example. For example, after receiving the second polling frame, the device #C starts channel contention at the second preset moment.

In a possible design, the second preset moment is a moment at which the second polling frame is received. That is, after receiving the second polling frame, the second device starts channel contention.

In another example, the second preset moment may be a moment configured by the first device for the second device. In this case, the second polling frame may carry information about the second preset moment. The device #C is used as an example. For example, after receiving the second polling frame, the device #C starts channel contention at the second preset moment.

The foregoing describes the two manners as an example. This is not limited in this embodiment of this application. A manner in which the second device can determine, based on the second polling frame, to start channel contention is applicable to this embodiment of this application.

For content included in the second polling frame, refer to the description in the method 800. In addition, different from the method 800, in the method 1100, the time information of the N second devices in the second polling frame indicates time information for channel contention of the second device.

1120: The device #C transmits data after successfully contending for a channel.

Optionally, when a second device successfully contends for a channel and performs transmission, transmission duration may be carried in a sent frame (for example, a data frame), to indicate duration of a sub-transmit opportunity (sub-TXOP) of the second device. It should be understood that the sub-transmit opportunity is merely a name for distinguishing between different functions. In a future protocol, all names used to represent a same function fall within the protection scope of embodiments of this application.

In an example, the duration of the sub-transmit opportunity may be carried in a duration field of the frame. After receiving the frame sent by the second device, another second device may set the duration of the sub-transmit opportunity to a value of a sub-network allocation vector (NAV) (for example, denoted as a sub-NAV). The another second device cannot contend for a channel when the value of the sub-NAV is greater than 0; and the another second device can contend for a channel only when the value of the sub-NAV is 0.

Optionally, when the second device transmits data in a channel contention manner, the first device may also transmit data.

For example, if the first device does not know which second devices need to share the time resource #1, the solution described in the method 1100 may be used.

Based on the foregoing solution, a plurality of devices may share a time resource. For example, the first device may send the second polling frame to the device #C. The second polling frame indicates the device #C to start channel contention at the second preset time. In this way, each second device may transmit data in a channel contention manner based on a second polling frame received by each second device. Therefore, coordination between the plurality of devices can be implemented, and the plurality of devices can also directly send data to a STA, so that data can be transmitted freely, transmission latency can be reduced, and flexibility of data transmission can be improved.

In this application, the foregoing methods may be used independently, or may be used in combination. For example, the method 300 and the method 700 may be used independently, as described in each of the methods above.

In an example, the method 400 and the method 800 may be used independently, as described in the foregoing methods. Alternatively, the method 400 and the method 800 may be used in combination. In another example, the method 600 and the method 1100 may be used independently, as described in the foregoing methods. Alternatively, the method 600 and the method 1100 may be used in combination.

The following separately describes cases in which the methods are used in combination.

FIG. 12 is a schematic diagram of interaction in a method 1200 for coordinated communication according to another embodiment of this application. The method 1200 may include the following steps.

1210: A first device sends a first announcement frame. The first announcement frame includes identifier information of N second devices, and the first announcement frame indicates a second device that can use a time resource #1.

In an example, the first device may send the first announcement frame after obtaining a time resource (for example, a TXOP).

In another example, the first device may first transmit data after obtaining a time resource (for example, a TXOP), and send the first announcement frame after the data transmission completes.

It should be understood that, for a specific occasion for sending the first announcement frame by the first device, reference may be made to the description in the foregoing method 400. Details are not described herein again.

Optionally, the first announcement frame may further include time information of the N second devices.

Optionally, the first announcement frame may further include channel information of each second device and/or sequence information of the N second devices.

For information related to the first announcement frame, such as the identifier information of the N second devices, the time information of the N second devices, the channel information of each second device, the sequence information of the N second devices, and a frame structure of the first announcement frame, refer to the description in the foregoing method 400. Details are not described herein again.

1220: The first device sends a first polling frame to a device #A. The first polling frame indicates the device #A to start to use, at first preset time, a channel resource shared by the first device with the device #A.

For the first polling frame, refer to the description in the method 800. Details are not described herein again.

Optionally, if the first announcement frame carries the time information of the N second devices, and the first polling frame also carries the time information of the N second devices, the second device may use the time information of the N second devices carried in the first polling frame. The device #A is used as an example. For example, the device #A starts to use, based on the first preset time indicated by the first polling frame, the channel resource shared by the first device with the device #A. The device #A is used as an example. For another example, the device #A uses, based on information about maximum duration indicated by the first polling frame, the channel resource shared by the first device with the device #A.

In this manner, the first device can dynamically allocate an appropriate resource to each second device based on an actual status of data transmission of the second device, improving resource utilization.

Optionally, if N is 1, or if the device #A is the first second device polled (that is, the device #A is the first second device that uses the time resource #1), the first device may not send the first polling frame, and the first announcement frame serves as the first polling frame.

1230: The device #A transmits data in a specified time period.

For example, the device #A may transmit data on a specified link, on a specified channel, and in a specified time period.

Optionally, if maximum transmission duration allocated (or granted) to the second device is not used up, the first device or another second device is notified in any one of the following processing manners.

Processing manner 1: The second device sends a return frame to the first device.

The device #A is used as an example. If the maximum transmission duration allocated to the device #A is not used up, the device #A may send a return frame to the first device. The return frame is used to return a remaining time resource of the time resource allocated by the first device to the device #A.

Optionally, if the device #A has no data to be transmitted, the device #A may directly send the return frame to the first device.

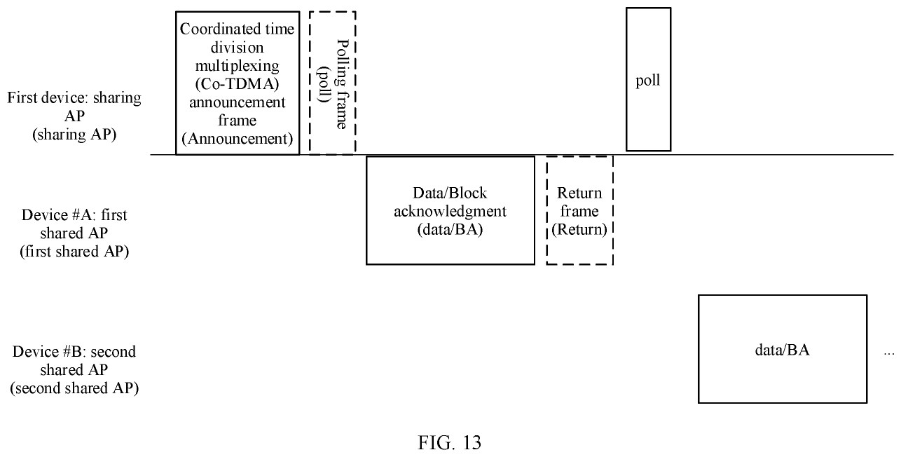

Optionally, as shown in FIG. 13, after receiving the return frame sent by the device #A, the first device may continue to send the first polling frame to a device #B, to indicate that the device #B may start to use, at the first preset time, the channel resource shared by the first device with the device #B. The device #B may be a next second device, that is, a second device that can use the channel resource #1 after the device #A.

It is assumed that the devices are APs. The device #A is denoted as the first shared device (first shared AP), and the device #B is denoted as the second shared device (second shared AP). In addition, a coordination type of the device is coordinated time division multiplexing (time division multiple access, TDMA) (coordinated TDMA, co-TDMA), that is, a coordination manner based on time resource sharing.

As shown in FIG. 13, after sending an announcement (that is, the first announcement frame) to the device #A (first shared AP), the first device (sharing AP) may further send a poll (that is, the first polling frame) to the device #A, and the device #A performs data or block acknowledgment (block ACK) (data/BA) transmission. If the maximum transmission duration allocated to the device #A is not used up, the device #A may send the return frame (denoted as return) to the first device. After receiving the return frame sent by the device #A, the first device may continue to send the first polling frame to the device #B, to indicate that the device #B may start to use, at the first preset time, the channel resource shared by the first device with the device #B. After receiving the poll, the device #B may transmit data/BA on a specified link, on a specified channel, and in a specified time period. In addition, the device #B may use a time resource that is not used up by the device #A.

For the processing manner 1, refer to the description in the foregoing method 800. Details are not described herein again.

Processing manner 2: The second device sends a transfer frame to a next second device.

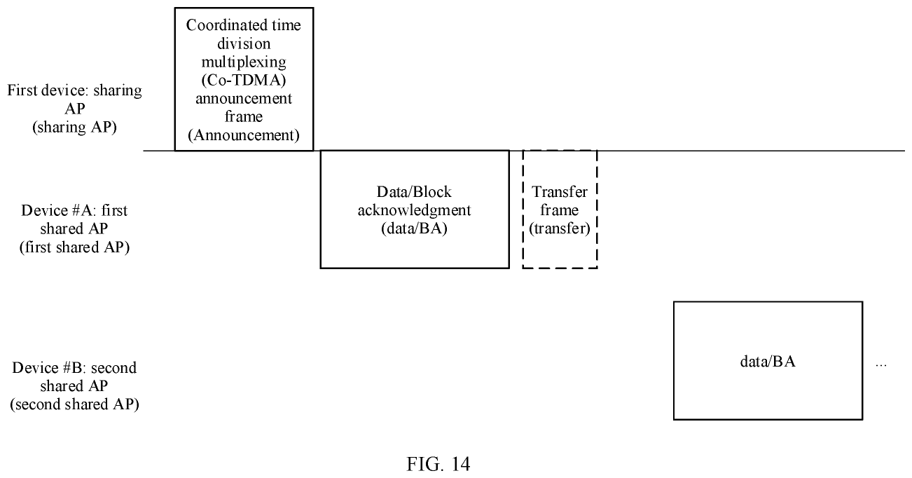

In this embodiment of this application, a time period that is not used up by a second device may be postponed to a next second device for use. For example, as shown in FIG. 14, a time period that is not used up by the device #A may be postponed to the device #B for use.

As shown in FIG. 14, after the first device (sharing AP) sends an announcement (that is, the first announcement frame) to the device #A (first shared AP), the device #A performs data or block acknowledgment (block ACK) (data/BA) transmission. If the maximum transmission duration allocated to the device #A is not used up, the device #A may send a transfer frame (denoted as transfer) to the device #B. After receiving the transfer frame sent by the device #A, the device #B may directly perform transmission. For example, after receiving the transfer frame sent by the device #A, the device #B may transmit data/BA on a specified link, on a specified channel, and in a specified time period. In addition, the device #B may use a time resource that is not used up by the device #A.

Optionally, the first polling frame may also carry indication information #2. The indication information #2 indicates whether a second device can use a time period that is not used up by a previous second device. For example, if the indication information #2 carried in the first polling frame indicates that a second device can use a time period that is not used up by a previous second device, the device #B may use the time period that is used up by the device #A. For another example, if the indication information #2 carried in the first polling frame indicates that a second device cannot use a time period that is not used up by a previous second device, the device #B cannot use the time period that is used up by the device #A.

For the processing manner 2, refer to the description in the foregoing method 800. Details are not described herein again.

Processing manner 3: The second device may send indication information #3, to indicate to return an unused part of the transmit opportunity.

For the processing manner 3, refer to the description in the foregoing method 800. Details are not described herein again.

The foregoing briefly describes a solution combining the method 400 and the method 800 with reference to FIG. 12 to FIG. 14. For details, refer to the descriptions in the method 400 and the method 600.

In this embodiment of this application, a plurality of devices may share a time resource. For example, the first device may send an announcement frame (that is, the first announcement frame), and the first announcement frame may indicate a second device that can share a time resource with the first device. In addition, the first device may further send a polling frame (that is, the first polling frame) to the second device, and the first polling frame indicates that the second device may start to use, at the first preset time, the channel resource shared by the first device with the second device. In this way, coordination between the plurality of devices can be implemented, resource utilization can also be improved, and another device does not need to perform channel contention again. This can reduce overheads caused by channel contention performed again by the another device. In addition, in this embodiment of this application, the plurality of devices may directly send data to a STA, so that data can be transmitted freely, transmission latency can be reduced, and flexibility of data transmission can be improved.

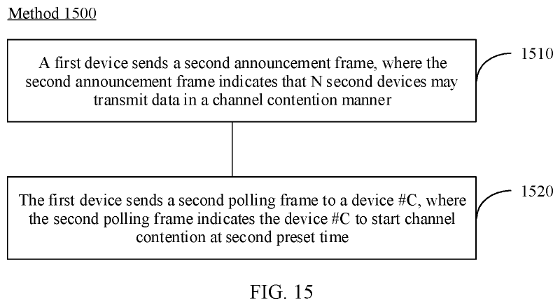

FIG. 15 is a schematic diagram of interaction in a method 1500 for coordinated communication according to another embodiment of this application. The method 1500 may include the following steps.

1510: A first device sends a second announcement frame. The second announcement frame indicates that N second devices may transmit data in a channel contention manner.

Optionally, the second announcement frame may carry indication information (that is, indication information #1), and the indication information indicates that N second devices may transmit data in a channel contention manner.

Optionally, the second announcement frame may further include time information of the N second devices.

For the second announcement frame, refer to the foregoing description in the method 600. Details are not described herein again.

1520 (optional): The first device sends a second polling frame to a device #C. The second polling frame indicates the device #C to start channel contention at second preset time.

Optionally, the second polling frame may carry the indication information (that is, the indication information #1), and the indication information indicates that the N second devices may transmit data in a channel contention manner. It may be understood that the indication information #1 may be carried in the second announcement frame, or may be carried in the second polling frame. This is not limited.

Optionally, if N is 1, or if the device #C is the first second device polled (that is, the device #C is the first second device that performs channel contention), the first device may not send the second polling frame, and the second announcement frame serves as the second polling frame.

For the second polling frame, refer to the description in the method 1100. Details are not described herein again.

Optionally, if the second announcement frame carries the time information of the N second devices, and the second polling frame also carries the time information of the N second devices, the second device may use the time information of the N second devices carried in the second polling frame. The device #C is used as an example. For example, the device #C start channel contention based on the second preset time indicated by the second polling frame.

In this manner, the first device can dynamically indicate, for each second device, appropriate time information for channel contention based on an actual status of data transmission of the second device. This can improve resource utilization.

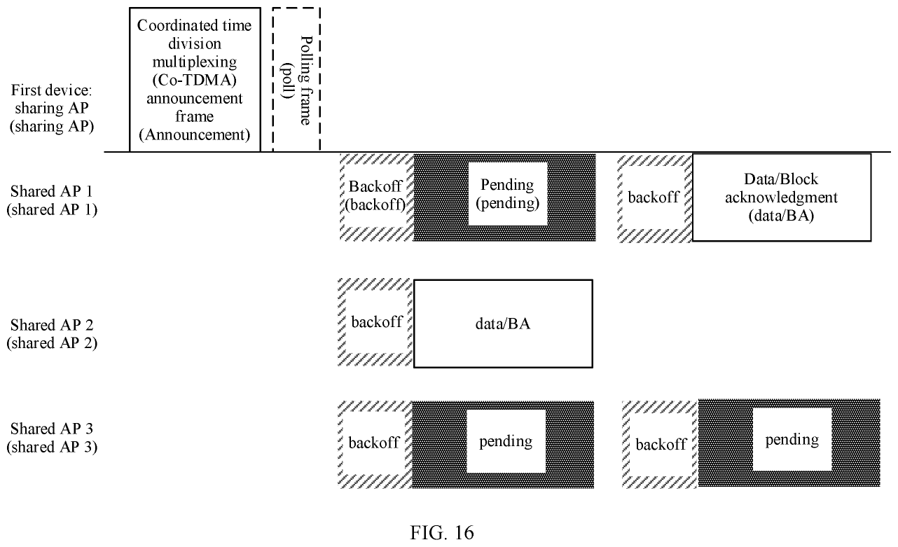

In an example, duration of a sub-transmit opportunity may be carried in a duration field of a frame. After receiving the frame sent by the second device, another second device may set the duration of the sub-transmit opportunity to a value of a sub-NAV (for example, denoted as a sub-NAV). As shown in FIG. 16, the another second device cannot contend for a channel when the value of the sub-NAV is greater than 0; and the another second device can contend for a channel only when the value of the sub-NAV is 0.

It is assumed that the devices are APs. The first device is denoted as a sharing device (sharing AP), and the second device is denoted as a shared device (shared AP). In addition, a coordination type of the device is co-TDMA, that is, a coordination manner based on time resource sharing.

As shown in FIG. 16, the first device is the sharing AP, and access points that shares a TXOP include a shared AP 1, a shared AP 2, and a shared AP 3. After sending an announcement frame (that is, the second announcement frame), the first device (sharing AP) may further send a poll (that is, the second polling frame) to the shared APs, and the shared APs start channel contention. After successfully contending for a channel, a shared AP may transmit data/BA. As shown in FIG. 16, the shared AP 2 successfully contends for a channel, and the shared AP 2 may transmit data/BA. When the shared AP 2 transmit data/BA, other second devices such as the shared AP 1 and the shared AP 3 cannot contend for a channel, that is, are in a pending state or a contention pending state. After the shared AP 2 completes data transmission, the other shared APs can contend for a channel.

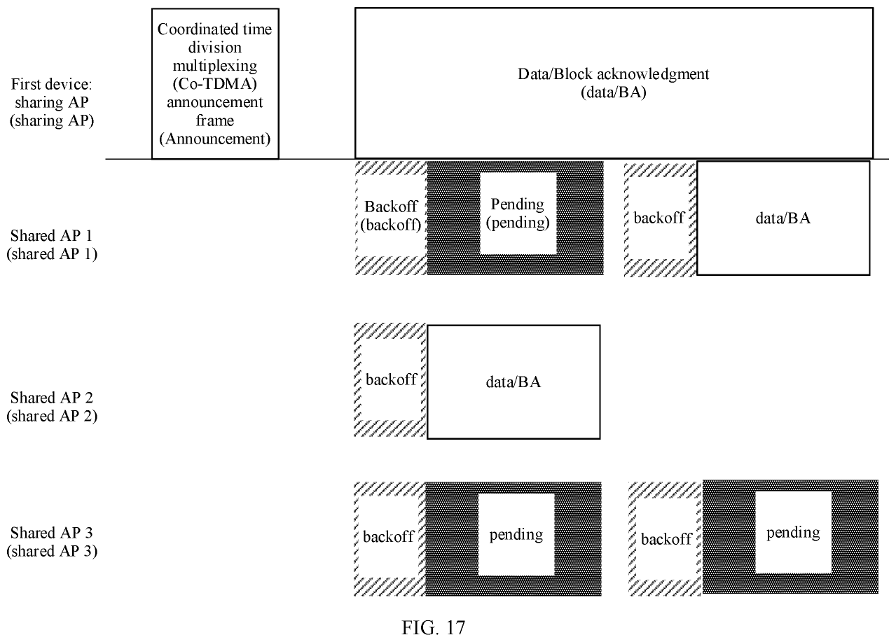

Optionally, as shown in FIG. 17, when the second device transmits data in a channel contention manner, the first device may also transmit data.

It is assumed that the devices are APs. The first device is denoted as a sharing device (sharing AP), and the second device is denoted as a shared device (shared AP). In addition, a coordination type of the device is co-TDMA, that is, a coordination manner based on time resource sharing.

As shown in FIG. 17, the first device is the sharing AP, and access points that shares a TXOP include a shared AP 1, a shared AP 2, and a shared AP 3. The first device may send a coordinated spatial reuse (Co-SR) trigger frame to trigger one or more shared APs to perform transmission with the first device in a contention manner.

The foregoing briefly describes a solution combining the method 600 and the method 1100 with reference to FIG. 15 to FIG. 17. For details, refer to the descriptions in the method 600 and the method 1100.

In this embodiment of this application, a plurality of devices may share a time resource. For example, the first device may send an announcement frame (that is, the second announcement frame), and the second announcement frame may indicate that the N second devices may transmit data in a channel contention manner. In addition, the first device may further send a polling frame (that is, the second polling frame) to the second device, and the second polling frame indicates that the second device may start channel contention at the second preset time. In this way, coordination between the plurality of devices can be implemented, and resource utilization can also be improved. In addition, in this embodiment of this application, the plurality of devices may directly send data to a STA, so that data can be transmitted freely, transmission latency can be reduced, and flexibility of data transmission can be improved.

The foregoing describes, with reference to FIG. 3 to FIG. 17, a solution of sharing a time resource between a plurality of devices. The AP devices have more and more resources, for example, more bandwidth (for example, 320 megahertz (Mega Hertz, MHz)), more streams (for example, 16 spatial streams (NSS)), more links, and the like. Therefore, for the AP, a maximum TXOP length may carry more bits, and may not be exhausted by a single AP (for example, the first AP). Therefore, the first AP may share a resource of the first AP with another AP (the second AP). For example, the first AP shares a TXOP of the first AP after data transmission. For example, embodiments of this application provide a procedure and an algorithm for sharing a time resource between a plurality of devices, for example, solutions described in the method 300, the method 400, the method 600, the method 700, the method 800, the method 1100, the method 1200, and the method 1500, and possible frame structures of the announcement frames (such as the first announcement frame and the second announcement frame), the polling frames (such as the first polling frame and the second polling frame), the return frames, and the transfer frames in FIG. 3 to FIG. 17. In this way, the time resource can be shared between the plurality of devices. Based on embodiments of this application, coordination between the plurality of devices can be implemented, and the plurality of devices can also directly send data to a STA, so that data can be transmitted freely, transmission latency can be reduced, and flexibility of data transmission can be improved.

In addition, it should be understood that the solution of the return frame may be applied to a solution in which only an announcement message is sent, for example, the method 300, the method 400, or the method 600, may be applied to a solution in which only a polling message is sent, for example, the method 700, the method 800, or the method 1100, or may be applied to a solution in which an announcement message and a polling message are combined, for example, the method 1200 or the method 1500. This is not limited.

The following describes possible preparations before the coordination between the plurality of devices. It should be understood that solutions described below may be used independently, or may be used in combination with the solutions described in FIG. 3 to FIG. 17.

Before multi-device coordination, some preparations may be made to ensure that the coordination can proceed effectively. The time resource sharing mechanism provided in this embodiment of this application is used as an example. Before the time resource sharing mechanism is implemented, some preparations may be made to ensure that the mechanism can operate effectively. There are a plurality of forms of multi-device coordination. An application scenario of a solution provided in a following embodiment is not limited to the time resource sharing mechanism, and may be further used in another coordination scenario, for example, coordinated OFDMA, coordinated beamforming, joint transmission, or coordinated spatial reuse.

The following describes in detail possible preparations before coordination between APs with devices being APs, where a first AP is a sharing AP, and a second AP is a shared AP. Several possible preparations described below may be used independently, or may be used in combination. This is not limited herein.

1. Possible Preparation 1

Possible preparation 1: The second AP notifies the first AP of a transmission requirement of the second AP, so that the first AP shares (or grants) a transmit opportunity with (or to) the second AP.

In a possible implementation, the second AP may send request information, to request to transmit data in a multi-AP coordination form.

For example, the request information may be sent by the second AP to the first AP, or may be broadcast by the second AP. This is not limited herein.

It should be understood that the request information is merely a name for distinguishing between different functions, and does not limit the protection scope of embodiments of this application. For example, the request information may also be referred to as resource request information.

Optionally, the request information may include one or more of the following: a coordination type, a quantity of resources needed for transmission, a service volume that needs to be transmitted, and a scheduling policy to be used. Descriptions are made below separately.

(1) Coordination Type

The coordination type indicates a coordination type expected by the second AP. For example, the coordination type may include but is not limited to the following coordination types: coordinated time division multiplexing (TDMA) (coordinated TDMA), coordinated frequency division multiplexing (FDMA) (coordinated FDMA), coordinated orthogonal frequency division multiplexing (coordinated OFDMA), coordinated beamforming, coordinated spatial reuse, and the like.

For example, the request information may include the coordination type. Information about the coordination type is carried in the request information, so that the first AP learns of the coordination type requested by the second AP, and the first AP makes corresponding preparations based on the requested coordination type.

(2) Quantity of Resources Needed for Transmission

The quantity of resources needed for transmission indicates a quantity of resources needed by the second AP for data transmission. For example, the quantity of resources needed for transmission may include but is not limited to the following information: transmission duration needed for transmission, a channel bandwidth needed for transmission, and a transmit power needed for transmission.

For example, the request message may include the quantity of resources needed for transmission. The quantity of resources needed for transmission is carried in the request information, so that the first AP can learn of a transmission resource needed by the second AP for data transmission, and the first AP allocates an appropriate transmission resource to the second AP, improving resource utilization.

(3) Service Volume that Needs to be Transmitted

The service volume that needs to be transmitted indicates a service volume transmitted by the second AP. For example, the service volume that needs to be transmitted may include but is not limited to the following information: a service direction (for example, an uplink service, a downlink service, or a bidirectional service), a service type (a service access class or a service identifier), a quantity of stations (STA number) that need to be served, a quantity of bytes that need to be transmitted, a length of a queue to be transmitted (for example, a buffer size), and a latency requirement of a service that needs to be transmitted (for example, maximum tolerable waiting latency of each service type), and whether there is an emergency service to be transmitted.

For example, the request information may include the service volume that needs to be transmitted. The service volume that needs to be transmitted is carried in the request information, so that the first AP can allocate an appropriate transmission resource to or perform corresponding configuration on the second AP based on the service volume that needs to be transmitted by the second AP. This can improve resource utilization.

(4) Scheduling Policy to be Used

The scheduling policy to be used indicates a scheduling policy to be used by the second AP. For example, the scheduling policy to be used may include but is not limited to the following information: resource block allocation information of a channel and a transmission parameter. For example, the transmission parameter may include but is not limited to a modulation and coding set (MCS), a number of spatial streams (NSS), or transmit power.

For example, the request information may include the scheduling policy to be used. The scheduling policy to be used is carried in the request information, so that the first AP can learn of the scheduling policy to be used by the second AP, and the first AP performs corresponding configuration or preparation.

Content that may be included in the request information is listed above by using examples. It should be understood that this embodiment of this application is not limited thereto. For example, when sending the request information to the first AP, the second AP may notify the first AP of all content related to transmission.

Optionally, the request information may be included in a beacon frame in a form of an information element and broadcast. In this way, all APs can receive the request information, to send a coordinated transmission request to the second AP.

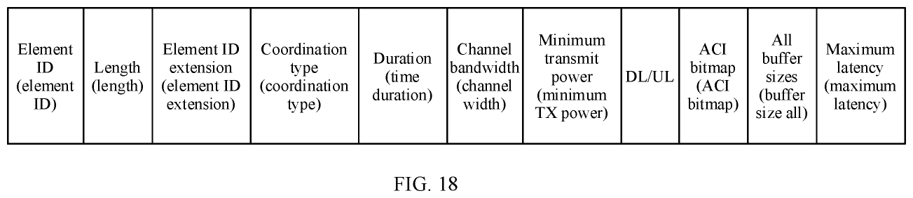

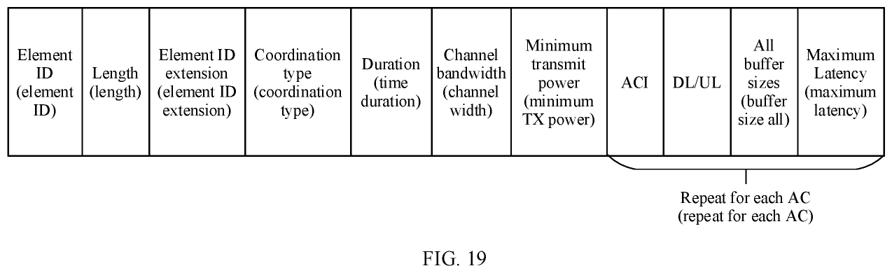

A specific form of the request information is not limited in this embodiment of this application. With reference to possible frame structures shown in FIG. 18 and FIG. 19, the following describes a possible frame structure applicable to the request information by using an example.

In a possible design, the request information may be carried by using a frame structure shown in FIG. 18.

For example, as shown in FIG. 18, the frame structure may include an element ID, a length (that is, a frame length), element ID extension, a coordination type, duration (time duration), a channel bandwidth, minimum transmit (Tx) power, uplink (UL)/downlink (DL), and an access category index (ACI) bitmap (ACI bitmap), all buffer sizes, maximum latency (that is, maximum tolerable waiting latency). For content of each item, refer to the foregoing description.

In another possible design, the request information may be carried by using a frame structure shown in FIG. 19.

For example, as shown in FIG. 19, the frame structure may include an element ID, a length (that is, a frame length), element ID extension, a coordination type, duration (time duration), a channel bandwidth (channel width), minimum transmit (Tx) power, an ACI, uplink (UL)/downlink (DL), all buffer sizes, maximum latency (that is, maximum tolerable waiting latency).

For content of each item in FIG. 18 and FIG. 19, refer to the foregoing description.

It should be understood that the frame structures shown in FIG. 18 and FIG. 19 are merely examples for description. This is not limited in this embodiment of this application. For example, the frame may include more fields or fewer fields.

In addition, a motivation for sending the transmission requirement by the second AP is not limited in this embodiment of this application.

In an example, the request information may alternatively be obtained by the first AP through inquiring the second AP. For example, the first AP sends a trigger frame to the second AP, and the trigger frame may carry information about the coordination type. If the second AP expects to participate in this type of coordination, the second AP may send the request information to the first AP after receiving the trigger frame.

In another example, the second AP may actively send the transmission requirement to the first AP. For example, when the second AP wants to use a resource shared by the first AP, for example, a time resource (as shown in the solutions described in FIG. 3 to FIG. 17) or a frequency resource, the second AP may actively send the transmission requirement to the first AP.

The preparation 1 described above may be used independently, or may be used in combination with the solutions described in FIG. 3 to FIG. 17. For example, the first AP first learns of the transmission requirement of the second AP, and determines, based on the transmission requirement, whether to share the time resource of the first AP. When determining to share the time resource with one or more second APs, the first AP sends an announcement message or a polling message to the one or more second APs.

Based on the foregoing preparation 1, when the plurality of APs coordinate with each other, appropriate processing may be performed based on a transmission requirement of each AP, for example, a coordination type expected by the AP, a quantity of resources needed by the AP for data transmission, a service volume transmitted by the AP, and a scheduling policy to be used by the AP. For example, the first AP may perform corresponding configuration based on a coordination type expected by the second AP.

2. Possible Preparation 2

Possible preparation 2: establishing an AP coordination set.

The AP coordination set is a set of a plurality of APs, and APs belonging to a same AP coordination set may coordinate with each other, that is, initiate coordinated transmission with each other. There are many manners of establishing the AP coordination set. This is not limited in this embodiment of this application. For example, configuration may be performed in advance by using software, or there may be another establishment process.

In a possible implementation, the first AP may determine whether the second AP is a part of an AP candidate set, or the first AP may determine whether the second AP can participate in coordinated transmission initiated by the first AP. For example, the first AP may determine, based on a predefined mechanism, whether the second AP is a part of the AP candidate set, or determine whether the second AP can participate in coordinated transmission initiated by the first AP. The AP candidate set may include one or more APs. The one or more APs may participate in coordinated transmission initiated by the first AP, or may share a resource of the first AP, for example, a time resource (as shown in the solutions described in FIG. 3 to FIG. 17) or a frequency resource.

It should be understood that a manner of establishing an AP coordination set is not limited in this embodiment of this application.

Optionally, after the AP coordination set is established, information about the AP coordination set may be notified to a station, so that the station receives a data frame sent by another AP in the same AP coordination set.

Optionally, for example, the information about the AP coordination set may include one or more of the following: a coordinating type of each AP, a coordination set identifier, an identifier of each AP in the coordination set (which may be an address of an AP, for example, a media access control (MAC) address; or an AP ID in a short length, for example, a length of 11 bits or 12 bits), a basic service set color (BSS color) of each AP in the coordination set, and a working channel of each AP.

For example, the coordination set identifier may be represented by a coordination set color (group color). That is, the information about the AP coordination set may include a group color, and the group color may identify the AP coordination set.

For example, a working channel of each AP may represent a channel used by each AP for data transmission.

Optionally, the information about the AP coordination set may be defined as an information element, and then the information element is carried in a beacon frame and broadcast.

In a possible design, a frame structure of the information element may be divided based on each AP in coordination.

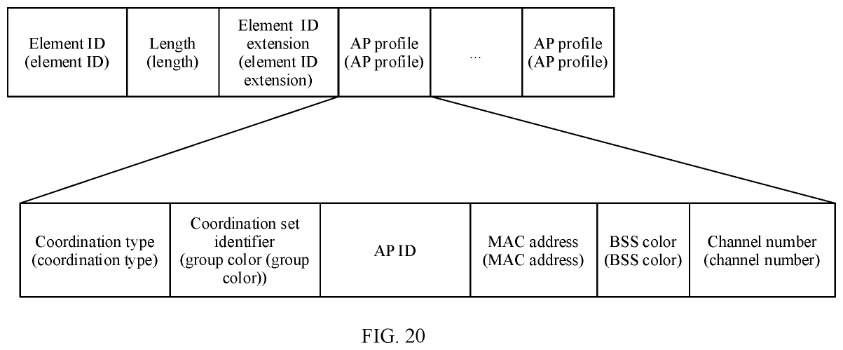

For example, the information about the AP coordination set may be carried by using a frame structure shown in FIG. 20.

For example, as shown in FIG. 20, the frame structure may include an element ID, a length (that is, a frame length), element ID extension, and AP profile.

For example, the AP profile may include a coordination type, a coordination set identifier (group color), an AP identifier (AP ID), an address (for example, a MAC address), a BSS color, and a working channel.

In another possible design, a frame structure of the information element may be divided based on a coordination type.

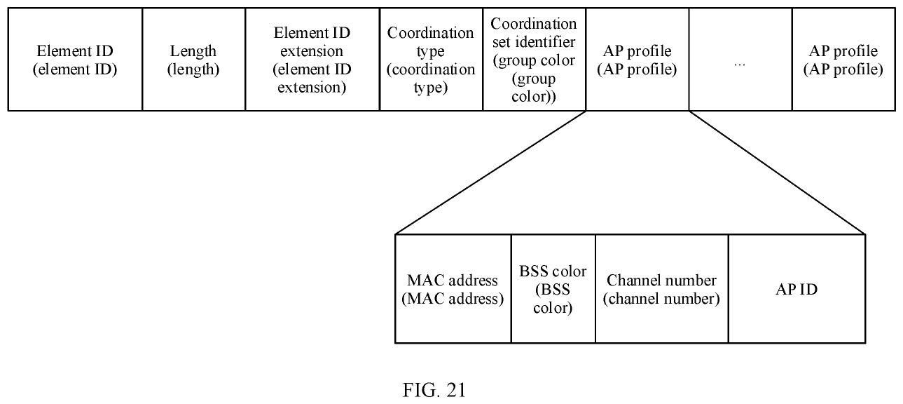

For another example, the information about the AP coordination set may be carried by using a frame structure shown in FIG. 21.

For example, as shown in FIG. 21, the frame structure may include an element ID, a length (that is, a frame length), element ID extension, a coordination type, a coordination set identifier (group color), and AP profile.

For example, the AP profile may include: an AP address (for example, a MAC address), a BSS color, a working channel, and an AP identifier (AP ID).

It should be understood that the frame structures shown in FIG. 20 and FIG. 21 are merely examples for description. This is not limited in this embodiment of this application. For example, the frame may include more fields or fewer fields.

Optionally, for multi-AP coordinated data transmission, information about an AP coordination set may be carried in a preamble part of a physical layer protocol data unit (PPDU) transmitted by an AP, to identify that the data transmission is multi-AP coordinated transmission, so that a station determines whether to accept a data frame. Specifically, for example, an AP coordination set identifier (for example, a group color) may be carried in a physical layer preamble of a PPDU. When a group color in a preamble of a data frame received by the STA is the same as a group color of an AP coordination set established by an AP associated with the STA, the STA should continue to receive the data frame because the data frame may include data sent to the STA.

The preparation 2 described above may be used independently, or may be used in combination with the solutions described in FIG. 3 to FIG. 17. For example, the first AP may first determine a second AP that can establish an AP coordination set with the first AP, and then send an announcement message or a polling message to the second AP.

The foregoing preparation 2 may be used independently, or may be used in combination with the foregoing preparation 1. For example, the first AP first learns of a transmission requirement of the second AP, and then establishes an AP coordination set based on the transmission requirement.

Based on the foregoing preparation 2, communication may be performed based on an established AP coordination set when a plurality of APs coordinate with each other. This can not only make coordination between the plurality of APs more coordinated, but also improve communication performance between the plurality of APs and the STA.

3. Possible Preparation 3

Possible preparation 3: broadcasting AP capability information.

Because there are a plurality of forms of AP coordination, an AP may broadcast an AP coordination form supported by the AP in a beacon frame, so that another AP establishes a coordination relationship with the AP. For example, the AP coordination form that is supported may include but is not limited to coordinated time division multiplexing (coordinated TDMA), coordinated frequency division multiplexing (coordinated FDMA), coordinated orthogonal frequency division multiplexing (coordinated OFDMA), coordinated beamforming, coordinated spatial reuse, and the like.

Optionally, one AP may support one coordination form, or may support a plurality of coordination forms, which is not limited herein.

In addition, for coordinated orthogonal frequency division multiplexing (coordinated OFDMA), different resource blocks may be used between APs.

For example, if a granularity of 20 MHz is used during resource block division, each of the plurality of APs switches to a temporary primary channel during data transmission.

For another example, if a granularity less than 20 MHz (for example, 26 subcarriers, 52 subcarriers, or 106 subcarriers) is used during resource block division, the plurality of APs send same physical layer preamble information during data transmission.

Optionally, the AP capability information may further include whether an AP supports switching to a temporary primary channel, and/or whether the AP supports sending of common physical layer preamble information. In other words, an AP may declare, in AP capability information, whether the AP supports switching to a temporary primary channel, and/or whether the AP supports sending of common physical layer preamble information. In this way, resource block division may be performed based on the capability information reported by the AP, to better adapt to performance of the AP.

The preparation 3 described above may be used independently, or may be used in combination with the solutions described in FIG. 3 to FIG. 17. For example, the second AP that supports multi-AP coordinated transmission may first send AP capability information, and the first AP determines, based on the AP capability information sent by the second AP, whether the first AP can share a time resource with the second AP. When determining that the first AP can share the time resource with the second AP, the first AP sends an announcement message or a polling message to the second AP.

The foregoing preparation 3 may be used independently, or may be used in combination with the foregoing preparation 1 and/or preparation 2. In an example, the second AP may first broadcast AP capability information of the second AP, for example, a coordination form supported by the second AP. Another AP, such as the first AP, may determine, based on the AP capability information of the second AP, whether to coordinate with the second AP. For example, when the coordination form supported by the second AP includes a coordination form expected by the first AP, the first AP may send an inquiry to the second AP, so that the second AP notifies the first AP of a transmission requirement.

Based on the preparation 3 described above, a plurality of APs may determine, based on AP capability information of each AP, whether to coordinate with each other. In this way, a more appropriate coordination relationship may be established, and performance of coordinated communication between the plurality of APs may also be improved.

It should be understood that the foregoing describes three possible preparations by using examples. This is not limited in this embodiment of this application. As described above, the possible preparations may be used independently, or may be used in combination. This is not limited herein.

In this embodiment of this application, preparations are made for multi-device (for example, multi-AP) coordinated transmission, so that the multi-device coordinated transmission can proceed effectively, and coordination between the multiple devices is more appropriate. This can improve overall performance of coordinated communication.

It should be understood that message names and field names in the foregoing embodiments are merely for distinguishing between different functions, and do not limit the protection scope of embodiments of this application. In a future protocol, all names used to represent a same function fall within the protection scope of embodiments of this application.

It should be further understood that the frame structures such as the frame structures of the announcement frame and the polling frame in some of the foregoing embodiments are all examples for description. Any variation of the frame structures falls within the protection scope of embodiments of this application.

It should be further understood that in some embodiments, an example in which a device is an AP is used for description. It should be understood that embodiments of this application may also be used in a scenario of coordination between any other devices, for example, a scenario of coordination between STAs.

Based on the foregoing technical solutions, a plurality of devices may share a time resource. For example, embodiments of this application provide a procedure and an algorithm for sharing a time resource between a plurality of devices, for example, solutions described in the method 300, the method 400, the method 600, the method 700, the method 800, the method 1100, the method 1200, and the method 1500, and possible frame structures of the announcement frames (such as the first announcement frame and the second announcement frame), the polling frames (such as the first polling frame and the second polling frame), the return frames, and the transfer frames in FIG. 3 to FIG. 17. In this way, the time resource can be shared between the plurality of devices. Based on embodiments of this application, coordination between the plurality of devices can be implemented, and the plurality of devices can also directly send data to a STA, so that data can be transmitted freely, transmission latency can be reduced, and flexibility of data transmission can be improved.

In addition, based on the foregoing technical solutions, preparations are made for multi-device (for example, multi-AP) coordinated transmission, so that the multi-device coordinated transmission can proceed effectively.

Embodiments described in this specification may be independent solutions, or may be combined based on internal logic. All these solutions fall within the protection scope of this application. For example, a solution of preparations before coordination between a plurality of devices may be used independently, or may be used in combination with the method 300, the method 400, the method 600, the method 700, the method 800, the method 1100, the method 1200, and the method 1500. For example, before step 310, before step 410, before step 610, before step 710, before step 810, before step 1110, or before step 1210, possible preparations (such as any one or more of the foregoing possible preparations) may be made before coordination between the plurality of devices.

It may be understood that the methods and operations implemented by the first device in the foregoing method embodiments may alternatively be implemented by a component (for example, a chip or a circuit) that may be used in the first device, and the methods and operations implemented by the second device in the foregoing method embodiments may alternatively be implemented by a component (for example, a chip or a circuit) that may be used in the second device.

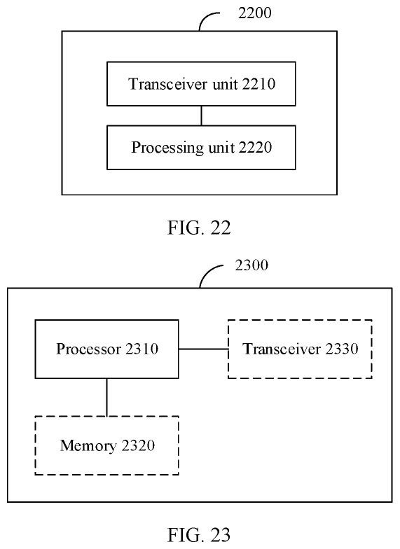

The methods provided in embodiments of this application are described in detail above with reference to FIG. 3 to FIG. 21. Apparatuses provided in embodiments of this application are described in detail below with reference to FIG. 22 to FIG. 25. It should be understood that descriptions of the apparatus embodiments correspond to the descriptions of the method embodiments. Therefore, for content that is not described in detail, refer to the foregoing method embodiments. For brevity, details are not described herein again.

The foregoing mainly describes the solutions provided in embodiments of this application from the perspective of interaction between devices. It can be understood that, to implement the foregoing functions, the devices, for example, the first device and the second device, include corresponding hardware structures and/or software modules for performing the functions. A person skilled in the art should be aware that, in combination with units and algorithm steps of the examples described in embodiments disclosed in this specification, this application may be implemented by hardware or a combination of hardware and computer software. Whether a function is performed by hardware or hardware driven by computer software depends on particular applications and design constraints of the technical solutions. A person skilled in the art may use different methods to implement the described functions for each particular application, but it should not be considered that the implementation goes beyond the protection scope of this application.

In embodiments of this application, the first device and the second device may be divided into functional modules based on the foregoing method examples. For example, the functional modules may be obtained through division based on corresponding functions, or two or more functions may be integrated into one processing module. The integrated module may be implemented in a form of hardware, or may be implemented in a form of a software functional module. It should be noted that, in embodiments of this application, division into the modules is an example, and is merely logical function division. In actual implementation, another feasible division manner may be available. An example in which each functional module is obtained through division based on a corresponding function is used below for description.

FIG. 22 is a schematic block diagram of an apparatus used in coordinated communication according to an embodiment of this application. An apparatus 2200 includes a transceiver unit 2210 and a processing unit 2220. The transceiver unit 2210 may implement a corresponding communication function, and the processing unit 2220 is configured to perform data processing. The transceiver unit 2210 may also be referred to as a communication interface or a communication unit.

Optionally, the apparatus 2200 may further include a storage unit. The storage unit may be configured to store instructions and/or data. The processing unit 2220 may read the instructions and/or data in the storage unit, to enable the apparatus to implement the foregoing method embodiments.

The apparatus 2200 may be configured to perform an action performed by the first device in the foregoing method embodiments. In this case, the apparatus 2200 may be the first device or a component that can be configured in the first device. The transceiver unit 2210 is configured to perform an operation related to sending/receiving on the first device side in the foregoing method embodiments. The processing unit 2220 is configured to perform an operation related to processing on the first device side in the foregoing method embodiments.

Alternatively, the apparatus 2200 may be configured to perform an action performed by the second device in the foregoing method embodiments. In this case, the apparatus 2200 may be the second device or a component that can be configured in the second device. The transceiver unit 2210 is configured to perform an operation related to sending/receiving on the second device side in the foregoing method embodiments. The processing unit 2220 is configured to perform an operation related to processing on the second device side in the foregoing method embodiments.

In a design, the apparatus 2200 is configured to perform an action performed by the first device in the method embodiments.

In a possible implementation, the processing unit 2220 is configured to obtain a transmit opportunity (TXOP); and the transceiver unit 2210 is configured to send an announcement message. The announcement message announces that the apparatus 2200 shares the TXOP, and the announcement message includes identifier information that indicates N second AP and information that indicates a time resource for the N second AP to perform communication in the TXOP, and N is an integer greater than or equal to 1.

In an example, the identifier information that indicates the N second AP includes an identifier of each second AP or a group identifier of a group to which a second AP belongs.

In another example, the information that indicates the time resource for the N second AP to perform communication in the TXOP includes one or more of the following: duration of a time resource for each second AP to perform communication in the TXOP, start time of the time resource for each second AP to perform communication in the TXOP, and end time of the time resource for each second AP to perform communication in the TXOP.

In another example, the announcement message includes one or more of the following: an identifier of a link used by each second AP, an identifier of a channel used by each second AP, or sequence information of the N second AP. The sequence information of the N second AP indicates a sequence of using the channel by the N second AP.

In another example, the N second AP include a third AP. The transceiver unit 2210 is further configured to send a first polling message to the third AP, and the first polling message indicates the third AP to start to use, at first preset time, a channel resource allocated to the third AP by the apparatus 2200.

In another example, the first polling message includes duration of using, by the third AP, the channel resource allocated by the apparatus 2200 to the third AP.

In another example, the N second AP include a fourth AP and a fifth AP. The processing unit 2220 is further configured to determine that data transmission of the fourth AP is completed. The transceiver unit 2210 is further configured to send a second polling message to the fifth AP, and the second polling message indicates the fifth AP to start to use, at second preset time, a channel resource allocated by the first AP to the fifth AP.

In another example, the transceiver unit 2210 is further configured to receive a return message from the fourth AP, and the processing unit 2220 is further configured to determine that data transmission of the fourth AP is completed. The return message is used to return a remaining time resource of the time resource allocated by the apparatus 2200 to the fourth AP. Alternatively, the transceiver unit 2210 is further configured to receive indication information from the fourth AP, and the processing unit 2220 is further configured to determine, based on the indication information, that data transmission of the fourth AP is completed. The indication information indicates to return a remaining time resource of the time resource allocated by the apparatus 2200 to the fourth AP.

In another example, the indication information is carried in any one of the following: a more data subfield in a control field of a last data frame transmitted by the fourth AP; a more fragment subfield in a quality of service control field of a last data frame transmitted by the fourth AP; an EOSP subfield in a quality of service control field of a last data frame transmitted by the fourth AP; a duration field of a last data frame transmitted by the fourth AP; or a more trigger frame (more TF) field of a last trigger frame transmitted by the fourth AP.

In another example, the transceiver unit 2210 is further configured to receive a request message from a second AP, and the request message is used to request to share the TXOP with the apparatus 2200.

In another example, the request message includes one or more of the following: a coordination type of the second AP is coordinated time division multiplexing, a transmission resource needed by the second AP, a service volume transmitted by the second AP, and a scheduling policy used by the second AP.

In another example, the transceiver unit 2210 is further configured to send information about an AP coordination set, and the information about the AP coordination set indicates coordinated transmission between the apparatus 2200 and an AP in the AP coordination set.

In another example, the information about the AP coordination set includes one or more of the following: a coordination type of the AP in the AP coordination set, an identifier of the AP coordination set, an identifier of the AP in the AP coordination set, a basic service set color BSS color of the AP in the AP coordination set, and a working channel of the AP in the AP coordination set.

In another possible implementation, the processing unit 2220 is configured to obtain a transmit opportunity (TXOP); and the transceiver unit 2210 is configured to send an announcement message. The announcement message announces that the apparatus 2200 shares the TXOP, and the announcement message includes indication information. The indication information indicates that N second AP can use, in a channel contention manner, a channel resource obtained by the apparatus 2200 in the TXOP, and N is an integer greater than or equal to 1.

In an example, the indication information includes information about a preset identifier, and the information about the preset identifier indicates that an AP that belongs to a same coordination set as the apparatus 2200 can use, in a channel contention manner, the channel resource obtained by the apparatus 2200 in the TXOP. The N second AP and the apparatus 2200 are APs belonging to the same coordination.

In another example, the indication information includes an identifier and transmission mode information of each second AP. The transmission mode information indicates whether the second AP uses, in a channel contention manner, the channel resource obtained by the apparatus 2200 in the TXOP.

In another example, the announcement message includes information that indicates a time resource on which each second AP can perform channel contention.

In another example, the information that indicates the time resource on which each second AP can perform channel contention includes one or more of the following: duration of channel contention of each second AP, start time of channel contention of each second AP, and end time of channel contention of each second AP.

In another example, the N second AP include a third AP. The transceiver unit 2210 is further configured to send a third polling message to the third AP, and the third polling message indicates the third AP to start channel contention at third preset time.

In another example, the transceiver unit 2210 is further configured to send parameter information, and the parameter information includes a parameter used by the second AP for channel contention.

In another example, the transceiver unit 2210 is further configured to receive a request message from a second AP, and the request message is used to request to share the TXOP with the apparatus 2200.

In another example, the request message includes one or more of the following: a coordination type of the second AP is coordinated time division multiplexing, a transmission resource needed by the second AP, a service volume transmitted by the second AP, and a scheduling policy used by the second AP.

In another example, the transceiver unit 2210 is further configured to send information about an AP coordination set, and the information about the AP coordination set indicates coordinated transmission between the apparatus 2200 and an AP in the AP coordination set.

In another example, the information about the AP coordination set includes one or more of the following: a coordination type of the AP in the AP coordination set, an identifier of the AP coordination set, an identifier of the AP in the AP coordination set, a basic service set color BSS color of the AP in the AP coordination set, and a working channel of the AP in the AP coordination set.

The apparatus 2200 may implement steps or procedures performed by the first device in FIG. 3 to FIG. 21 according to embodiments of this application. The apparatus 2200 may include units configured to perform the methods performed by the first device in FIG. 3 to FIG. 21. In addition, the units in the apparatus 2200 and the foregoing other operations and/or functions are separately used to implement corresponding procedures in FIG. 3 to FIG. 21.

For example, when the apparatus 2200 is configured to perform the method 300 in FIG. 3, the transceiver unit 2210 may be configured to perform step 310 in the method 300, and the processing unit 2220 may be configured to perform step 301 in the method 300.

For another example, when the apparatus 2200 is configured to perform the method 400 in FIG. 4, the transceiver unit 2210 may be configured to perform step 410 in the method 400.

For another example, when the apparatus 2200 is configured to perform the method 600 in FIG. 6, the transceiver unit 2210 may be configured to perform step 610 in the method 600.

For another example, when the apparatus 2200 is configured to perform the method 700 in FIG. 7, the transceiver unit 2210 may be configured to perform step 710 in the method 700, and the processing unit 2220 may be configured to perform step 701 in the method 700.

For another example, when the apparatus 2200 is configured to perform the method 800 in FIG. 8, the transceiver unit 2210 may be configured to perform step 810 in the method 800.

For another example, when the apparatus 2200 is configured to perform the method 1100 in FIG. 11, the transceiver unit 2210 may be configured to perform step 1110 in the method 1100.

For another example, when the apparatus 2200 is configured to perform the method 1200 in FIG. 12, the transceiver unit 2210 may be configured to perform steps 1210 and 1220 in the method 1200.

For another example, when the apparatus 2200 is configured to perform the method 1500 in FIG. 15, the transceiver unit 2210 may be configured to perform steps 1510 and 1520 in the method 1500.

It should be understood that a specific process in which the units perform the foregoing corresponding steps is described in detail in the foregoing method embodiments, and for brevity, details are not described herein.

In another design, the apparatus 2200 is configured to perform an action performed by the second device in the method embodiment in FIG. 3.

In a possible implementation, the transceiver unit 2210 is configured to receive an announcement message from a first AP. The announcement message announces that the first AP shares a transmit opportunity (TXOP), and the announcement message includes identifier information that indicates N second AP and information that indicates a time resource for the N second AP to perform communication in the TXOP. The N second AP include the apparatus 2200, and N is an integer greater than or equal to 1.

In an example, the identifier information that indicates the N second AP includes an identifier of each second AP or a group identifier of a group to which a second AP belongs.

In another example, the information that indicates the time resource for the N second AP to perform communication in the TXOP includes one or more of the following: duration of a time resource for each second AP to perform communication in the TXOP, start time of the time resource for each second AP to perform communication in the TXOP, and end time of the time resource for each second AP to perform communication in the TXOP.

In another example, the announcement message includes one or more of the following: an identifier of a link used by each second AP, an identifier of a channel used by each second AP, or sequence information of the N second AP. The sequence information of the N second AP indicates a sequence of using the channel by the N second AP.

In another example, the transceiver unit 2210 is further configured to receive a first polling message from the first AP. The first polling message indicates the apparatus 2200 to start to use, at first preset time, a channel resource allocated by the first AP to the apparatus 2200. The processing unit 2220 is configured to start to use, at the first preset time based on the first polling message, the channel resource allocated by the first AP to the apparatus 2200.

In another example, the transceiver unit 2210 is further configured to send a return message to the first AP. The return message is used to return a remaining time resource of the time resource allocated by the first AP to the apparatus 2200. Alternatively, the transceiver unit 2210 is further configured to send a transfer message to a fourth AP. The transfer message is used to transfer a remaining time resource of the time resource allocated by the first AP to the apparatus 2200, and the fourth AP belongs to the N second AP.

In another example, the transceiver unit 2210 is further configured to send indication information. The indication information indicates the remaining time resource of the time resource allocated by the first AP to the apparatus 2200.

In another example, the indication information is carried in any one of the following: a more data subfield in a control field of a last data frame transmitted by the apparatus 2200; a more fragment subfield in a quality of service control field of a last data frame transmitted by the apparatus 2200; an EOSP subfield in a quality of service control field of a last data frame transmitted by the apparatus 2200; a duration field of a last data frame transmitted by the apparatus 2200; or a more trigger frame (more TF) field of a last trigger frame transmitted by the apparatus 2200.

In another example, the transceiver unit 2210 is further configured to send a request message to the first AP. The request message is used to request to share the TXOP with the first AP.

In another example, the request message includes one or more of the following: a coordination type coordinated time division multiplexing of the apparatus 2200, a transmission resource needed by the apparatus 2200, a service volume transmitted by the apparatus 2200, and a scheduling policy to be used by the apparatus 2200.

In another possible implementation, the transceiver unit 2210 is configured to receive an announcement message from a first AP. The announcement message announces that the first AP shares a transmit opportunity (TXOP), and the announcement message includes indication information. The indication information indicates that N second AP can use, in a channel contention manner, a channel resource obtained by the first AP in the TXOP, the N second AP include the apparatus 2200, and N is an integer greater than or equal to 1.

In an example, the indication information includes information about a preset identifier. The information about the preset identifier indicates that an AP that belongs to a same coordination set as the first AP can use, in a channel contention manner, the channel resource obtained by the first AP in the TXOP. The N second AP and the first AP are APs belonging to the same coordination set.

In another example, the indication information includes an identifier and transmission mode information of each second AP. The transmission mode information indicates the second AP to use, in a channel contention manner, the channel resource obtained by the first AP in the TXOP. The processing unit 2220 is configured to determine, based on the transmission mode information, to use, in a channel contention manner, the channel resource obtained by the first AP in the TXOP.

In another example, the announcement message includes information that indicates a time resource on which each second AP can perform channel contention. The processing unit 2220 is configured to perform channel contention based on the information that is in the announcement message and that indicates a time resource on which the apparatus 2200 can perform channel contention.

In another example, the information that indicates the time resource on which each second AP can perform channel contention includes one or more of the following: duration of channel contention of each second AP, start time of channel contention of each second AP, and end time of channel contention of each second AP.

In another example, the transceiver unit 2210 is further configured to receive a third polling message from the first AP. The third polling message indicates the apparatus 2200 to start channel contention at third preset time. The processing unit 2220 is configured to perform channel contention based on the third polling message.

In another example, the transceiver unit 2210 is further configured to receive parameter information from the first AP. The parameter information includes a parameter used by the apparatus 2200 for channel contention.

In another example, the transceiver unit 2210 is further configured to send a request message to the first AP. The request message is used to request to share the TXOP with the first AP.

In another example, the request message includes one or more of the following: a coordination type coordinated time division multiplexing of the apparatus 2200, a transmission resource needed by the apparatus 2200, a service volume transmitted by the apparatus 2200, and a scheduling policy to be used by the apparatus 2200.

In still another possible implementation, the transceiver unit 2210 is configured to receive a transfer message from a third AP. The transfer message is used to transfer, to the apparatus 2200, a remaining time resource of a time resource allocated by the first AP to the third AP. The processing unit 2220 is configured to transmit data on a channel resource allocated by the first AP to the apparatus 2200. The first AP can share a transmit opportunity (TXOP) of the first AP with N second AP, the N second AP include the third AP and the apparatus 2200, and N is an integer greater than or equal to 2.

In an example, the processing unit 2220 is further configured to transmit data on the remaining time resource of the time resource allocated by the first AP to the third AP.

The apparatus 2200 may implement steps or procedures performed by the second device in FIG. 3 to FIG. 21 according to embodiments of this application. The apparatus 2200 may include units configured to perform the methods performed by the second device in FIG. 3 to FIG. 21. In addition, the units in the apparatus 2200 and the foregoing other operations and/or functions are separately used to implement corresponding procedures in FIG. 3 to FIG. 21.

For example, when the apparatus 2200 is configured to perform the method 300 in FIG. 3, the transceiver unit 2210 may be configured to perform step 310 in the method 300.

For another example, when the apparatus 2200 is configured to perform the method 400 in FIG. 4, the transceiver unit 2210 may be configured to perform step 410 in the method 400, and the processing unit 2220 may be configured to perform step 420 in the method 400.

For another example, when the apparatus 2200 is configured to perform the method 600 in FIG. 6, the transceiver unit 2210 may be configured to perform step 610 in the method 600, and the processing unit 2220 may be configured to perform step 620 in the method 600.

For another example, when the apparatus 2200 is configured to perform the method 700 in FIG. 7, the transceiver unit 2210 may be configured to perform step 710 in the method 700.

For another example, when the apparatus 2200 is configured to perform the method 800 in FIG. 8, the transceiver unit 2210 may be configured to perform step 810 in the method 800, and the processing unit 2220 may be configured to perform step 820 in the method 800.

For another example, when the apparatus 2200 is configured to perform the method 1100 in FIG. 11, the transceiver unit 2210 may be configured to perform step 1110 in the method 1100, and the processing unit 2220 may be configured to perform step 1120 in the method 1100.

For another example, when the apparatus 2200 is configured to perform the method 1200 in FIG. 12, the transceiver unit 2210 may be configured to perform steps 1210 and 1220 in the method 1200.

For another example, when the apparatus 2200 is configured to perform the method 1500 in FIG. 15, the transceiver unit 2210 may be configured to perform steps 1510 and 1520 in the method 1500.

It should be understood that a specific process in which the units perform the foregoing corresponding steps is described in detail in the foregoing method embodiments, and for brevity, details are not described herein.

The processing unit 2220 in the foregoing embodiment may be implemented by at least one processor or a processor-related circuit. The transceiver unit 2210 may be implemented by using a transceiver or a transceiver-related circuit. The transceiver unit 2210 may also be referred to as a communication unit or a communication interface. The storage unit may be implemented by using at least one memory.

As shown in FIG. 23, an embodiment of this application further provides an apparatus 2300 used in coordinated communication. The apparatus 2300 includes a processor 2310. The processor 2310 is coupled to a memory 2320. The memory 2320 is configured to store a computer program or instructions and/or data. The processor 2310 is configured to execute the computer program or the instructions and/or the data stored in the memory 2320, so that the methods in the foregoing method embodiments are performed.

Optionally, the apparatus 2300 includes one or more processors 2310.

In an example, as shown in FIG. 23, the apparatus 2300 may further include the memory 2320.

Optionally, the apparatus 2300 may include one or more memories 2320.

In an example, the memory 2320 and the processor 2310 may be integrated, or disposed separately.

In an example, as shown in FIG. 23, the apparatus 2300 may further include a transceiver 2330. The transceiver 2330 is configured to receive and/or send a signal. For example, the processor 2310 is configured to control the transceiver 2330 to receive and/or send a signal.

In a solution, the apparatus 2300 is configured to implement the operations performed by the first device in the foregoing method embodiments.

For example, the processor 2310 is configured to perform an operation related to processing and performed by the first device in the foregoing method embodiments, and the transceiver 2330 is configured to perform an operation related to sending/receiving and performed by the first device in the foregoing method embodiments.

In another solution, the apparatus 2300 is configured to implement the operations performed by the second device in the foregoing method embodiments.

For example, the processor 2310 is configured to perform an operation related to processing and performed by the second device in the foregoing method embodiments, and the transceiver 2330 is configured to perform an operation related to sending/receiving and performed by the second device in the foregoing method embodiments.

An embodiment of this application further provides an apparatus 2400 used in coordinated communication. The apparatus 2400 may be a first device, a second device, or a chip. The apparatus 2400 may be configured to perform an operation performed by the first device or the second device in the foregoing method embodiments.

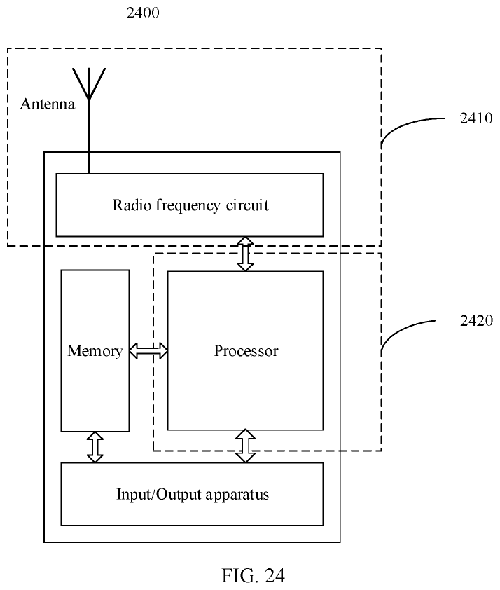

When the apparatus 2400 is the first device, or when the apparatus 2400 is the second device, the apparatus 2400 may be, for example, a station device. FIG. 24 shows a simplified schematic diagram depicting a structure of a station device. The station device may be a first device, or may be a second device. As shown in FIG. 24, the station device (that is, the first device or the second device) includes a processor, a memory, a radio frequency circuit, an antenna, and an input/output apparatus. The processor is mainly configured to process a communication protocol and communication data, control the station device, execute a software program, process data of the software program, and the like. The memory is mainly configured to store the software program and the data. The radio frequency circuit is mainly configured to perform conversion between a baseband signal and a radio frequency signal, and process the radio frequency signal. The antenna is mainly configured to send and receive a radio frequency signal in a form of an electromagnetic wave. The input/output apparatus, such as a touchscreen, a display, or a keyboard, is mainly configured to receive data input by a user and output data to the user. It should be noted that station devices of some types may have no input/output apparatus.

When data needs to be sent, the processor performs baseband processing on to-be-sent data, and outputs a baseband signal to the radio frequency circuit. After performing radio frequency processing on the baseband signal, the radio frequency circuit sends the radio frequency signal in a form of an electromagnetic wave through the antenna. When data is sent to the station device, the radio frequency circuit receives a radio frequency signal through the antenna, converts the radio frequency signal into a baseband signal, and outputs the baseband signal to the processor. The processor converts the baseband signal into data and processes the data. For ease of description, FIG. 24 shows only one memory and one processor. An actual station device product may have one or more processors and one or more memories. The memory may also be referred to as a storage medium, a storage device, or the like. The memory may be disposed independent of the processor, or may be integrated with the processor. This is not limited in embodiments of this application.

In this embodiment of this application, the antenna and the radio frequency circuit that have sending and receiving functions may be considered as a transceiver unit of the station device, and the processor that has a processing function may be considered as a processing unit of the station device.

As shown in FIG. 24, the station device includes a transceiver unit 2410 and a processing unit 2420. The transceiver unit 2410 may also be referred to as a transceiver, a transceiver machine, a transceiver apparatus, or the like. The processing unit 2420 may also be referred to as a processor, a processing board, a processing module, a processing apparatus, or the like.

Optionally, a component that is in the transceiver unit 2410 and that is configured to implement a receiving function may be considered as a receiving unit, and a component that is in the transceiver unit 2410 and that is configured to implement a sending function may be considered as a sending unit. In other words, the transceiver unit 2410 includes a receiving unit and a sending unit. The transceiver unit sometimes may also be referred to as a transceiver machine, a transceiver, a transceiver circuit, or the like. The receiving unit sometimes may also be referred to as a receiver machine, a receiver, a receiving circuit, or the like. The sending unit sometimes may also be referred to as a transmitter machine, a transmitter, a transmitting circuit, or the like.

For example, the station device is a first device, that is, the apparatus 2400 is a first device.

For example, in an implementation, the processing unit 2420 is configured to perform an action of processing on the first device side in FIG. 3. For example, the processing unit 2420 is configured to perform a step of processing in step 301 in FIG. 3, and the transceiver unit 2410 is configured to perform an operation of sending/receiving in step 310 in FIG. 3.

For another example, in an implementation, the transceiver unit 2410 is configured to perform an operation of sending/receiving in step 410 in FIG. 4, and the processing unit 2420 is configured to perform a step of processing in FIG. 4.

For another example, in an implementation, the transceiver unit 2410 is configured to perform an operation of sending/receiving in step 610 in FIG. 6, and the processing unit 2420 is configured to perform a step of processing in FIG. 6.

For another example, in an implementation, the transceiver unit 2410 is configured to perform an operation of sending/receiving in step 710 in FIG. 7, and the processing unit 2420 is configured to perform a step of processing in step 701 in FIG. 7.

For another example, in an implementation, the transceiver unit 2410 is configured to perform an operation of sending/receiving in step 810 in FIG. 8, and the processing unit 2420 is configured to perform a step of processing in FIG. 8.

For another example, in an implementation, the transceiver unit 2410 is configured to perform an operation of sending/receiving in step 1110 in FIG. 11, and the processing unit 2420 is configured to perform a step of processing in FIG. 11.

For another example, in an implementation, the transceiver unit 2410 is configured to perform an operation of sending/receiving in steps 1210 and 1220 in FIG. 12, and the processing unit 2420 is configured to perform a step of processing in FIG. 12.

For another example, in an implementation, the transceiver unit 2410 is configured to perform an operation of sending/receiving in steps 1510 and 1520 in FIG. 15, and the processing unit 2420 is configured to perform a step of processing in FIG. 15.

It should be understood that when the apparatus 2400 is a second device, the transceiver unit 2410 may be configured to perform an operation of sending/receiving on the second device side in FIG. 3 to FIG. 21, and the processing unit 2420 may be configured to perform a step of processing of the second device in FIG. 3 to FIG. 21.

It should be further understood that FIG. 24 is merely an example instead of a limitation. The foregoing station device (that is, the first device or the second device) including the transceiver unit and the processing unit may not depend on the structure shown in FIG. 24.

When the apparatus 2400 is a chip, the chip includes a transceiver unit and a processing unit. The transceiver unit may be an input/output circuit or a communication interface. The processing unit may be a processor, a microprocessor, or an integrated circuit that is integrated on the chip. Certainly, when the apparatus 2400 is a chip system or a processing system, a device in which the apparatus 2400 is installed can implement the methods and the functions in embodiments of this application. For example, the processing unit 2420 may be a processing circuit in the chip system or the processing system, to control a device in which the chip system or the processing system is installed, or may be coupled to and connected to a storage unit, to invoke an instruction in the storage unit, so that the device can implement the methods and the functions in embodiments of this application. The transceiver unit 2410 may be an input/output circuit in the chip system or the processing system, to output information processed by the chip system, or input to-be-processed data or signaling information into the chip system for processing. For example, the apparatus 2400 may be a Wi-Fi chip, so that an apparatus in which the chip is installed can communicate with another device by using a 802.11 protocol.

An embodiment of this application further provides an apparatus 2500 used in coordinated communication. The apparatus 2500 may be a first device, a second device, or a chip. The apparatus 2500 may be configured to perform an operation performed by the first device or the second device in the foregoing method embodiments.

When the apparatus 2500 is a first device or a second device, for example, the apparatus 2500 may be an access point device. FIG. 20 shows a simplified schematic diagram depicting a structure of an access point device. The access point device may be a first device, or may be a second device. The access point device (that is, the first device or the second device) includes a part 2510 and a part 2520. The part 2510 is mainly configured to send and receive a radio frequency signal and convert the radio frequency signal and a baseband signal. The part 2520 is mainly configured to perform baseband processing, control the access point device, and the like. The part 2510 may usually be referred to as a transceiver unit, a transceiver machine, a transceiver circuit, a transceiver, or the like. The part 2520 is usually a control center of the access point device, and may be usually referred to as a processing unit, and is configured to control the access point device to perform an operation of processing on the second device side or the first device side in the foregoing method embodiments.

The transceiver unit in the part 2510 may also be referred to as a transceiver machine, a transceiver or the like. The transceiver unit includes an antenna and a radio frequency circuit, where the radio frequency circuit is mainly configured to perform radio frequency processing. Optionally, a component that is in the part 2510 and that is configured to implement a receiving function may be considered as a receiving unit, and a component that is configured to implement a sending function may be considered as a sending unit. In other words, the part 2510 includes a receiving unit and a sending unit. The receiving unit may also be referred to as a receiver machine, a receiver, a receiving circuit, or the like. The sending unit may be referred to as a transmitter machine, a transmitter, a transmitting circuit, or the like.

The part 2520 may include one or more boards, and each board may include one or more processors and one or more memories. The processor is configured to read and execute a program in the memory to implement a baseband processing function and control the second device. If there are a plurality of boards, the boards may be interconnected to enhance a processing capability. In an optional implementation, a plurality of boards may share one or more processors, a plurality of boards share one or more memories, or a plurality of boards simultaneously share one or more processors.

For example, the access point device is a second device, that is, the apparatus 2500 is a second device.

For example, in an implementation, the transceiver unit in the part 2510 is configured to perform a step related to sending/receiving performed by the second device in the embodiment shown in FIG. 3; and the part 2520 is configured to perform a step related to processing performed by the second device in the embodiment shown in FIG. 3.

For example, in an implementation, the transceiver unit in the part 2510 is configured to perform a step related to sending/receiving performed by the second device in the embodiment shown in FIG. 4; and the part 2520 is configured to perform a step related to processing performed by the second device in the embodiment shown in FIG. 4.

For example, in an implementation, the transceiver unit in the part 2510 is configured to perform a step related to sending/receiving performed by the second device in the embodiment shown in FIG. 6; and the part 2520 is configured to perform a step related to processing performed by the second device in the embodiment shown in FIG. 6.

For example, in an implementation, the transceiver unit in the part 2510 is configured to perform a step related to sending/receiving performed by the second device in the embodiment shown in FIG. 7; and the part 2520 is configured to perform a step related to processing performed by the second device in the embodiment shown in FIG. 7.

For example, in an implementation, the transceiver unit in the part 2510 is configured to perform a step related to sending/receiving performed by the second device in the embodiment shown in FIG. 8; and the part 2520 is configured to perform a step related to processing performed by the second device in the embodiment shown in FIG. 8.

For example, in an implementation, the transceiver unit in the part 2510 is configured to perform a step related to sending/receiving performed by the second device in the embodiment shown in FIG. 11; and the part 2520 is configured to perform a step related to processing performed by the second device in the embodiment shown in FIG. 11.

For example, in an implementation, the transceiver unit in the part 2510 is configured to perform a step related to sending/receiving performed by the second device in the embodiment shown in FIG. 12; and the part 2520 is configured to perform a step related to processing performed by the second device in the embodiment shown in FIG. 12.

For example, in an implementation, the transceiver unit in the part 2510 is configured to perform a step related to sending/receiving performed by the second device in the embodiment shown in FIG. 15; and the part 2520 is configured to perform a step related to processing performed by the second device in the embodiment shown in FIG. 15.

It should be understood that when the apparatus 2500 is a first device, the transceiver unit in the part 2510 may be configured to perform an operation of sending/receiving on the first device side in FIG. 3 to FIG. 21, and the part 2520 may be configured to perform a step of processing of the first device in FIG. 3 to FIG. 21.

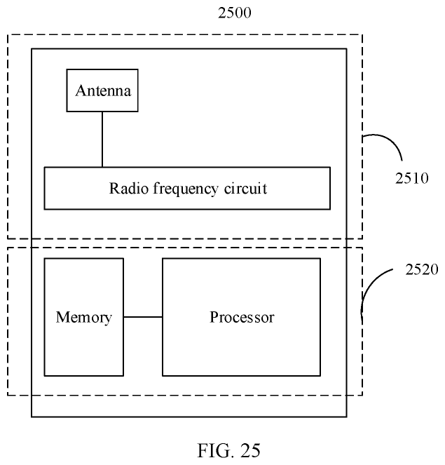

It should be understood that FIG. 25 is merely an example instead of a limitation. The foregoing access point device (that is, the first device or the second device) including the transceiver unit and the processing unit may not depend on the structure shown in FIG. 25.

When the apparatus 2500 is a chip, the chip includes a transceiver unit and a processing unit. The transceiver unit may be an input/output circuit or a communication interface. The processing unit is a processor, a microprocessor, or an integrated circuit integrated on the chip. Certainly, the apparatus 2500 may also be a chip system or a processing system, so that a device in which the apparatus 2500 is installed can implement the methods and the functions in embodiments of this application. For example, the processing unit 2520 may be a processing circuit in the chip system or the processing system, to control a device in which the chip system or the processing system is installed, or may be coupled to and connected to a storage unit, to invoke an instruction in the storage unit, so that the device can implement the methods and the functions in embodiments of this application. The transceiver unit 2510 may be an input/output circuit in the chip system or the processing system, to output information processed by the chip system, or input to-be-processed data or signaling information into the chip system for processing. For example, the apparatus 2500 may be a Wi-Fi chip, so that an apparatus in which the chip is installed can communicate with another device by using a 802.11 protocol.

An embodiment of this application further provides a computer-readable storage medium. The computer-readable storage medium stores computer instructions used to implement the methods performed by the first device or the methods performed by the second device in the foregoing method embodiments.

For example, when the computer program is executed by a computer, the computer is enabled to implement the methods performed by the first device or the methods performed by the second device in the foregoing method embodiments.

An embodiment of this application further provides a computer program product including instructions. When the instructions are executed by a computer, the computer is enabled to implement the methods performed by the first device or the methods performed by the second device in the foregoing method embodiments.

An embodiment of this application further provides a communication system. The communication system includes the first device and the second device in the foregoing embodiments.

For explanations and beneficial effects of related content of any one of the apparatuses provided above, refer to the corresponding method embodiment provided above. Details are not described herein again.

It should be understood that, the processor mentioned in embodiments of this application may be a central processing unit (CPU), another general-purpose processor, a digital signal processor (DSP), an application-specific integrated circuit (ASIC), a field programmable gate array (FPGA) or another programmable logic device, a discrete gate or transistor logic device, a discrete hardware component, or the like. The general-purpose processor may be a microprocessor, or the processor may be any conventional processor or the like.

It may be further understood that the memory mentioned in embodiments of this application may be a volatile memory or a nonvolatile memory, or may include a volatile memory and a nonvolatile memory. The nonvolatile memory may be a read-only memory (ROM), a programmable read-only memory (PROM), an erasable programmable read-only memory (EPROM), an electrically erasable programmable read-only memory (EEPROM), or a flash memory. The volatile memory may be a random access memory (RAM). For example, the RAM may be used as an external cache. By way of example but not limitation, the RAM may include a plurality of forms in the following: a static random access memory (static RAM, SRAM), a dynamic random access memory (dynamic RAM, DRAM), a synchronous dynamic random access memory (synchronous DRAM, SDRAM), a double data rate synchronous dynamic random access memory (double data rate SDRAM, DDR SDRAM), an enhanced synchronous dynamic random access memory (enhanced SDRAM, ESDRAM), a synchlink dynamic random access memory (synchlink DRAM, SLDRAM), and a direct rambus random access memory (direct rambus RAM, DR RAM).

It should be noted that when the processor is a general-purpose processor, a DSP, an ASIC, an FPGA, another programmable logic device, a discrete gate or a transistor logic device, or a discrete hardware component, the memory (storage module) may be integrated into the processor.

It should be further noted that the memory described in this specification is intended to include, but is not limited to, these memories and any other memory of a suitable type.

A person of ordinary skill in the art may be aware that, in combination with the examples described in embodiments disclosed in this specification, units and steps may be implemented by electronic hardware or a combination of computer software and electronic hardware. Whether the functions are performed by hardware or software depends on particular applications and design constraints of the technical solutions. A person skilled in the art may use different methods to implement the described functions for each particular application, but it should not be considered that the implementation goes beyond the protection scope of this application.

A person skilled in the art may clearly understand that, for the purpose of convenient and brief description, for detailed working processes of the foregoing system, apparatus, and unit, reference may be made to corresponding processes in the foregoing method embodiments. Details are not described herein again.

In the several embodiments provided in this application, it should be understood that the disclosed apparatuses and methods may be implemented in other manners. For example, the described apparatus embodiments are merely examples. For example, division into the units is merely logical function division and may be other division in actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in an electronic form, a mechanical form, or another form.

The units described as separate parts may or may not be physically separate, and parts displayed as units may or may not be physical units, to be specific, may be located in one position, or may be distributed on a plurality of network units. A part or all of the units may be selected based on an actual requirement to implement the solutions provided in this application.

In addition, functional units in embodiments of this application may be integrated into one unit, or each of the units may exist alone physically, or two or more units are integrated into one unit.

All or a part of the foregoing embodiments may be implemented by software, hardware, firmware, or any combination thereof When software is used to implement the embodiments, all or a part of the embodiments may be implemented in a form of a computer program product. The computer program product includes one or more computer instructions. When the computer program instructions are loaded and executed on a computer, the procedures or functions according to embodiments of this application are all or partially generated. The computer may be a general-purpose computer, a dedicated computer, a computer network, or another programmable apparatus. For example, the computer may be a personal computer, a server, a network device, or the like. The computer instructions may be stored in a computer-readable storage medium or may be transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line (DSL)) or wireless (for example, infrared, radio, or microwave) manner. The computer-readable storage medium may be any usable medium accessible by the computer, or a data storage device, for example, a server or a data center, integrating one or more usable media. The usable medium may be a magnetic medium (for example, a floppy disk, a hard disk, or a magnetic tape), an optical medium (for example, a DVD), a semiconductor medium (for example, a solid state disk, (SSD)), or the like. For example, the usable medium may include but is not limited to any medium that can store program code, such as a USB flash drive, a removable hard disk, a read-only memory (ROM), a random access memory (RAM), a magnetic disk, or an optical disc.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims and the specification.

1. A method for coordinated communication comprising:
obtaining, by a first access point (AP), a transmit opportunity (TXOP); and
sending, by the first AP, an announcement message, wherein the announcement message announces that the first AP shares the TXOP;
wherein the announcement message comprises identifier information that indicates N second AP and information that indicates a time resource for the N second AP to perform communication in the TXOP, wherein N is an integer greater than or equal to 1.

2. The method according to claim 1, wherein the identifier information that indicates the N second AP comprises:
an identifier of each second AP, or a group identifier of a group to which a second AP belongs.

3. The method according to claim 1, wherein the information that indicates the time resource for the N second AP to perform the communication in the TXOP comprises one or more of the following:
duration of a time resource for each second AP to perform communication in the TXOP,
a start time of the time resource for each second AP to perform communication in the TXOP, and
an end time of the time resource for each second AP to perform communication in the TXOP.

4. The method according to claim 1, wherein the N second AP comprise a third AP, and
the method further comprises:
sending, by the first AP, a first polling message to the third AP, wherein the first polling message indicates the third AP to start to use, at a first preset time, a channel resource allocated by the first AP to the third AP.

5. The method according to claim 1, wherein the N second AP comprise a fourth AP, and the method further comprises:
receiving, by the first AP, indication information from the fourth AP, wherein the indication information indicates a remaining time resource of a time resource allocated by the first AP to the fourth AP; and
determining, by the first AP based on the indication information, that data transmission of the fourth AP is completed.

6. The method according to claim 5, wherein the indication information is carried in any one of the following:
a more data subfield in a control field of a last data frame transmitted by the fourth AP;
a more fragment subfield in a quality of service control field of the last data frame transmitted by the fourth AP;
an end of service period (EOSP) subfield in the quality of service control field of the last data frame transmitted by the fourth AP;
a duration field of the last data frame transmitted by the fourth AP; or
a more trigger frame field of the last trigger frame transmitted by the fourth AP.

7. The method according to claim 1, further comprising:
receiving, by the first AP, a request message from the second AP before sending the announcement message, wherein the request message requests to share the TXOP with the first AP.

8. The method according to claim 7, wherein the request message comprises one or more of the following:
a coordination type of the second AP is coordinated time division multiplexing, a transmission resource needed by the second AP, a service volume transmitted by the second AP, and a scheduling policy used by the second AP.

9. The method according to claim 1, further comprising:
sending, by the first AP, information about an AP coordination set, wherein the information about the AP coordination set indicates coordinated transmission between the first AP and an AP in the AP coordination set.

10. A first access point (AP) comprising:
a memory, configured to store computer instructions; and
at least one processor, configured to execute the computer instructions to cause the first AP to:
obtain a transmit opportunity (TXOP); and
send an announcement message, wherein the announcement message announces that the first AP shares the TXOP, wherein the announcement message comprises identifier information that indicates N second AP and information that indicates a time resource for the N second AP to perform communication in the TXOP, wherein N is an integer greater than or equal to 1.

11. The first AP according to claim 10, wherein the identifier information that indicates the N second AP comprises:
an identifier of each second AP, or a group identifier of a group to which a second AP belongs.

12. The first AP according to claim 10, wherein the information that indicates the time resource for the N second AP to perform the communication in the TXOP comprises one or more of the following:
duration of a time resource for each second AP to perform communication in the TXOP,
a start time of the time resource for each second AP to perform communication in the TXOP, and
an end time of the time resource for each second AP to perform communication in the TXOP.

13. The first AP according to claim 10, wherein the N second AP comprise a third AP,
wherein the at least one processor is further configured to execute the computer instructions to cause the first AP to:
send a first polling message to the third AP, wherein the first polling message indicates the third AP to start to use, at a first preset time, a channel resource allocated by the first AP to the third AP.

14. The first AP according to claim 10, wherein the N second AP comprise a fourth AP, wherein the at least one processor is further configured to execute the computer instructions to cause the first AP to:
receive indication information from the fourth AP, wherein the indication information indicates a remaining time resource of a time resource allocated by the first AP to the fourth AP; and
determine, based on the indication information, that data transmission of the fourth AP is completed.

15. The first AP according to claim 14, wherein the indication information is carried in any one of the following:
a more data subfield in a control field of a last data frame transmitted by the fourth AP;
a more fragment subfield in a quality of service control field of the last data frame transmitted by the fourth AP;
an end of service period (EOSP) subfield in the quality of service control field of the last data frame transmitted by the fourth AP;
a duration field of the last data frame transmitted by the fourth AP; or a more trigger frame field of the last trigger frame transmitted by the fourth AP.

16. The first AP according to claim 10, wherein the at least one processor is further configured to execute the computer instructions to cause the first AP to:
receive a request message from the second AP before sending the announcement message, wherein the request message requests to share the TXOP with the first AP.

17. The first AP according to claim 16, wherein the request message comprises one or more of the following:
a coordination type of the second AP is coordinated time division multiplexing, a transmission resource needed by the second AP, a service volume transmitted by the second AP, and a scheduling policy used by the second AP.

18. The first AP according to claim 10, wherein the at least one processor is further configured to execute the computer instructions to cause the first AP to:
send information about an AP coordination set, wherein the information about the AP coordination set indicates coordinated transmission between the first AP and an AP in the AP coordination set.

19. A chip comprising:
a communication interface, configured to input and/or output information; and
at least one processor, configured to execute computer instructions stored in a memory, to cause a first access point (AP) comprising the chip to:
obtain a transmit opportunity (TXOP); and
send an announcement message, wherein the announcement message announces that the first AP shares the TXOP, wherein the announcement message comprises identifier information that indicates N second AP and information that indicates a time resource for the N second AP to perform communication in the TXOP, wherein N is an integer greater than or equal to 1.

20. The chip according to claim 19, wherein the identifier information that indicates the N second AP comprises:
an identifier of each second AP, or a group identifier of a group to which a second AP belongs.
